(19) United States
(12) Patent Application Publication
(10) Pub. No.: US 2019/0095959 A1
(43) Pub. Date: Mar. 28, 2019

(54) INTERNET OF ADVERTISEMENT METHOD AND SYSTEM

(71) Applicant: Hai Yu, Woodbury, MN (US)

(72) Inventor: Hai Yu, Woodbury, MN (US)

(21) Appl. No.: 15/713,703

(22) Filed: Sep. 25, 2017

(51) Int. Cl. G06Q 30/02

(52) U.S. Cl. CPC G06Q 30/0276; G06Q 30/0244; G06Q 30/0267; G06Q 30/0259; G06Q 30/0272; G06Q 30/0265; G06Q 30/0257

(57) ABSTRACT

System and method for providing advertisement network services in public advertising places for shared advertising among public service users. The system comprises an advertisement device that provides resources for playing advertisement data; an advertisement management controller that manages the advertisement resources to be shared among all advertisement requests from service users; a network controller that connects the system to service users via communication networks and connected computer devices for advertisement design, planning, and deployment. A service user first quotes the advertisement management controller with station ID to find out available advertisement schedule, playing methods and budget on an advertisement station. The service user next makes selection on advertising time slots and methods. After receiving the user submitted advisement request and data, the advertisement management controller updates the advertisement schedule and plays the advertisement data at specified time sequence, period, duration and event conditions.

### TECHNICAL FIELD

The present invention is in the field of advertisement, pertains more particularly to system and method for providing automated advertisement services using distributed advertisement stations for shared advertising among public service users.

### BACKGROUND

As the sharing economy is going at fast pace in many places from bike to basketball to cars, it is highly desirable to have a shared way to help people freely advertising their product and idea, in and near their daily living spaces, and to broadcast their new product news and continued innovations to customers, nearby or far away.

Present advertisement system, including TV commercials, radio commercials, street furniture, advertising signs, large screen, spectaculars, advertisement boards, billboards, etc., are owned by advertisement companies and are designed by specialists. Their usages are not easily accessible for public and small business owners, and their costs are also too high. They are not ideal advertising methods for our more and more dynamically and fast-changing societies as people desire to have a new advertisement system that can be used at any time, in any place, attractive to people and for small or big advertising purposes. The new advertisement system shall be more audience oriented to favor different needs from different groups, and to change its content and style in presence of different events. The new advertisement system supports flexible advertising schedule and it is capable of sharing among all advertising needs to reducing the advertising cost and to make such system available to any advertising customers in need.

In order to provide an automated advertising system and a service method to support shared advertising capabilities, this invention discloses an internet of advertisement system that not only enable the public to freely access this system for bringing their advertisement to anywhere they want and anytime they need, but also help the public to automatically generate high quality and professional advertisements simply based on their advertising descriptions and ideas.

The internet of advertisement system first comprises a network of advertisement stations distributed at assigned advertisement locations. The advertisement station comprises at least one advertisement device that provides resources for playing advertisement data. The advertisement station next comprises an advertisement management controller that manages the advertisement resources to be shared among all advertisement requests from service users. The advertisement station further comprises a network controller that enables service users to access the internet of advertisement system via wired or wireless communication networks from their terminal devices for advertisement design, planning, uploading and deploying. A central advertisement system server connects to many distributed advertisement stations to provide a higher level of advertising resource and advertisement schedule managements to satisfy the advertisement requests from service users either to specific advertisement stations or to advertise in large deployment regions.

The internet of advertisement system can either be accessed locally by pairing a user's terminal device with an advertisement management controller through wireless networks, or it can be accessed remotely by connecting to the central advertisement system server through internet. A service user first quotes the advertisement system with advertisement station ID to find out available advertisement resources including advertising schedule, methods, and budget options. The service user next select an advertising time slot and a plan that satisfy his/her advertisement requirements. After receiving the user submitted advisement request and data, the advertisement management controller updates the advertisement schedule on target advertisement devices and plays the advertisement data at user specified time sequence, period and duration.

The internet of advertisement system takes on-site and remote advertising request and starts playing customer designed advertising data right after successful submission. All the design, configuration and deployment processes are made automatically to be fast responsive to user's needs. For people with no advertisement design knowledge or experience, the invented system's advertisement design server not only provides users with high level advertisement design including configuration and templates, but also provides users with advertisement component generation engines that automatically generates advertisement data based on user provided input pattern and instructions using intelligent generative models. The resulted advertisement data are further refined and synthesized into high quality art designs while assuring compatibility for deployment to target advertisement stations.

The internet of advertisement system further equips camera, sensors and connected information sources at advertisement stations such that it can intelligently infer on-going and future environment conditions and events in order to provide timely, targeted and event triggered advertising capability. For example, advertisements favoring certain audience groups can be prioritized in displaying sequence when those audiences are recognized surrounding an advertisement station. Existing advertisements can also change their styles to the way that are more attractive to recognized audient groups.

With the automated and shared advertising services provided by the invented internet of advertisement system, future advertising in public are made easier and more accessible. It can be more focused on peoples' need locally and appropriately in time. It becomes part of the sharing economy in the advertisement sector. Less maintenance is expected. Expensive and time-consuming advertisement designs can now be avoided while high quality advertisement design can still be achieved using computer systems and artificial intelligence. As such, advertising cost can be largely reduced while an advertising process is much more effective and efficient. Future advertisement experiences become friendly and happy. And it can be imagined that people start advertising using their smartphone and computer at home, in office, on the street, or just by standing next to an advertisement station.

### SUMMARY OF THE INVENTION

The following summary provides an overview of various aspects of exemplary implementations of the invention. This summary is not intended to provide an exhaustive description of all of the important aspects of the invention, or to define the scope of the inventions. Rather, this summary is intended to serve as an introduction to the following description of illustrative embodiments.

Illustrative embodiments of the present invention are directed to a system with a computer readable medium encoded with instructions for providing automated advertisement services using distributed advertisement stations for shared advertising among public service users.

In a preferred embodiment of this invention, an advertisement station comprises an advertisement device, a network controller and an advertisement management controller (AMC). The advertisement device can be mobile or stationary including but not limited to TV, radio, street furniture, image/video projector, advertising signs, large screen, spectaculars, advertisement boards, billboards, and moving billboards on bus, train, etc. The advertisement device may also have accessory subsystems including but not limited to lighting and lighting pattern control subsystem, haptic and motion control subsystem, image projector and image projecting control subsystem, electro-mechanical equipment and operation subsystem, and service user specified subsystem and IO device. The network controller provides wired and/or wireless communication connections between the AMC and terminal devices of service users. The network controller also provides communication connection to higher level advertisement system and functionality servers, as well as advertisement system database. The network controller further connects AMC to extended internet information database and services for advanced advertisement service functionalities.

The AMC is a computerized device that comprises memory and processor to provide automated and shared advertising functionalities. When a service user is connected, the AMC first obtains identity information for the target advertisement station that the service user wants to advertise on. The AMC next loads the present advertisement schedule information of the target advertisement station and display the schedule on the terminal device of the service user. Available advertising time slots, method and plan option are given to the service user for making advertising choices. An advertisement request is then received after the service user makes decision on designed advertising method, advertising time slot and advertising plan that includes playing period, duration and budget. After that, The AMC updates the advertisement schedule for the target advertisement station by incorporating the advertisement request and the received advertisement data from the service user. It finally controls the advertisement device to play the user submitted advertisement data in accord with the updated advertisement schedule and user specified advertising method.

In an alternative embodiment of the present invention, the system for providing automated advertisement services is a networked advertisement service system that further comprises an advertisement system server. The advertisement system server provides higher level advertisement management and controls to a group of distributed advertisement stations that are connected to the advertisement system server through communication networks. In yet another embodiment of the present invention, a central advertisement system server is present to provide advertisement service management and control to a group of advertisement system servers.

In order to use the advertising service, a service user shall first provide identity information to tell either the AMC or the advertisement system server where to play user's advertisement data. There are many methods to help service users to achieve this. When staying close to a target advertisement station, the service user can capture a barcode associated to an advertisement device using his/her terminal device and transmit an identity message containing such barcode information to the AMC of the target advertisement station. Alternatively, the service user can capture a barcode associated to the target advertisement station and transmit an identity message to an advertisement system server to specify where to advertising with. The most convenient method is to pair with the network controller of the target advertisement station directly via its wireless network, like Wi-Fi or Bluetooth, using a terminal device like smartphone, tablet computer, etc. In this case, the identity information is obtained as the wireless network's identity. When a service user accesses the advertisement service remotely from the internet, or from a type of advertisement system server, a target advertisement station can be identified by its location, name or other type of IDs like serials number, sequence number or group ID, etc.

In some embodiments of the present invention, advertisement schedule information of a target advertisement station is displayed to a service user on his/her terminal device including a base advertisement cycle to define the fundamental advertisement operation period. A default advertisement play cycle is first used to illustrate how frequently do advertisements play. The service user can set his/her own advertisement play cycle that fits best to individual advertising frequency need. After that, advertisement playing sequence is rearranged and shown for each of advertisement play cycle. The advertisement schedule also comprises at least one advertising channel. Each advertisement channel corresponds to one available advertisement playing method, like video playing channel, split video playing channel, image displaying channel, audio channel, projecting channel and electro-mechanical operation channel, etc. The service user can make selection on advertising channels available on a target advertisement station to define the required advertising method. Within each advertisement play cycle, time sections are being partitioned into time slots. Unavailable time slots over advertising channels are blocked out from new requests. A service user can choose from any of the available time slots over advertising channels for playing advertisement data. After that, those newly booked time slots will be out of new requests.

In some embodiments of the present invention, the automated and public shared advertisement system comprises an advertisement generation server that provides methods to help service users designing professional advertisement data. The advertisement generation server first receives advertisement configuration data from a terminal device of a service user to generate a draft advertising proposal including advertisement format, style and candidate playing methods. Next, advertisement design prototype is generated including outline of advertising scenes, materials organization templates, when receiving advertisement description data from the user. Exemplary embodiments of the advertisement templates include a sequence of advertisement playing theme and episode/scene with assigned data playing channels, synchronized audio video and lighting effects, animation and human-acting styles, etc.

After that, the advertisement component design process starts. The advertisement generation server receives input pattern from the terminal device of a service user and process to determine its data type and format. Corresponding advertisement generator engine containing a certain type of generator model is then loaded to automatically draft advertisement component data using machine learning and computer processing methods. Until further quality refinement, the advertisement component data can be added to the draft advertising proposal to appropriate places in the advertisement design templates. The advertisement generation server can further take user designed advertisement materials to add to the draft advertising proposal. Additional refinements and modifications may be applied to polish the quality of the user supplied materials to provide overall high-quality advertisement design solution. At last, the finished draft advertising proposal is synthesized into advertisement data that is deployable to a target advertisement station.

In some embodiments of the present invention, the automated and public shared advertisement system comprises an advertisement authorization server that provides methods to verify user provided advertisement data and to approve advertisement request with respect to a target advertisement station. The advertisement authorization server first receives from a service user an advertisement approval request that contains target advertisement station ID, user account information and raw advertisement data. Based on the target advertisement station ID, station code of the target advertisement station is retrieved from an advertisement system database. This internal station code is for usage authorization purpose and is not open to service users. Next, user submitted raw advertisement data are processed with reviewing functions on attributes including content, format, quality, etc. The advertisement approval request can be approved by satisfying a set of advertising criteria. After that, advertisement data is generated from the raw advertisement data together with an authorized advertisement ID and embedded target advertisement station code. The advertisement data is readily deployable to be played on the target advertisement station. Such advertisement data can either be assigned directly to the target advertisement station given the service user's advertisement request is ready. Alternatively, the advertisement data is transmitted to the terminal device of a service user for afterwards advertisement request and submission.

In some embodiments of the present invention, the automated and public shared advertisement system comprises an advertisement information server that provides methods to enable advertisement information inquiry from service users. When the advertisement information server receives advertisement inquiry from a service user, it replies with additional information about the advertised topic to help the service user to learn more on his/her interested event, product and services. The inquired advertisement ID information is first recognized from a user's advertisement inquiry message. Such advertisement inquiry message can be in the format of voice record, image, photo, etc. Accordingly, the advertisement ID can either be a barcode, an advertising picture, a sentence containing key words, or a voice record while the user talked about what is needed. Once the advertisement ID is determined, at least one best-matching advertisement information will be retrieved from an advertisement information database. Such best-matching advertisement information can either be communicated back to user's terminal device or be transmitted to and displayed on an advertisement station where the inquiry happens.

In some embodiments of the present invention, the automated advertisement service system enables audience-oriented advertising when detecting the presence of certain prescribed event conditions. First, the AMC obtains video stream from at least one camera device associated to the advertisement station. It then detects and tracks objects and human in the video stream. The AMC further identifies characteristics, like age, gender, profession, dressing style, nationality, religion, education, etc., for people identified nearby or in crowds, as well as to recognize human activities. Statistical analysis is then carried out to synthesize and model present event condition based on the identified human characteristics, detected objects and recognized activities. Furthermore, future event conditions can also be predicted at a future time instance or in time series.

Next, advertisement-audience-relationship is evaluated. Based on such relationship, best-fitting advertisements can be assessed based on their properties like category, theme, target audience, user-specified relationship conditions, etc. These best-fitting advertisements will either be prioritized in the advertisement playing sequence to maximize its interest toward the present identified audiences, or be aligned in time towards upcoming customer or crowds. Furthermore, best-fitting advertisement style can also be inferred from such relationship assessment. Some or all of the advertisements can thus make change on their playing styles to provide the most elegant advertising towards the surrounding audience or to approaching audience at a future time period. Additionally, when certain group of people are identified, advertisements containing inappropriate contents can either be rearranged in advertisement schedule in order not to be played in front of those people, or such advertisements can be automatically reedited by removing unsuitable contents when detecting those people groups are approaching or nearby.

In some embodiments of the present invention, the automated advertisement service system enables environment-oriented advertising when detecting the presence of certain prescribed environmental event conditions. First, the AMC obtains measurement data from sensors associated to the advertisement station. Additional environmental and time information can also be obtained from connected information sources. Next, signal processing and information fusion are carried out to recognize surrounding environment, time and weather conditions in order to synthesize and model a present environmental event condition, as well as a future environment event condition. After that, advertisement-environment-relationship is evaluated. Based on such relationship, best-fitting advertisements can be assessed based on their properties like category, target surrounding environment and weather condition, user-specified relationship conditions, etc. These best-fitting advertisements will then either be prioritized in the advertisement playing sequence to make the advertisement more interesting in the present event conditions, or aligned in time to upcoming event conditions. Furthermore, best-fitting advertisement style can also be inferred from such relationship assessment. Some or all of the advertisements can thus make change on their playing styles to provide the most attractive advertising towards people in the present surrounding environment or in a future surrounding environment condition.

Illustrative embodiments of the present invention are directed to system and method for providing automated advertisement services using distributed advertisement stations for shared advertising among public service users. Exemplary embodiments of the invention comprise at least one advertisement device; at least one AMC; and at least one communication network controller. Additional features and advantages of the invention will be made apparent from the following detailed description of illustrative embodiments.

### BRIEF DESCRIPTION OF THE DRAWINGS

FIG. 1 is a schematic diagram of an automated advertisement system for providing shared advertising services among public service users using advertisement stations according to one or more embodiments;

FIG. 2 is a schematic diagram of an automated advertisement system for providing shared advertising services among public service users using distributed advertisement stations and a network based advertisement system server according to one or more embodiments;

FIG. 3 is a flowchart illustrating an automated advertising process for providing shared advertising services among public service users according to one or more embodiments;

FIG. 4 is a schematic diagram of advertisement schedule display and control method for service user to manage advertisement request according to one or more embodiments;

FIG. 5 is a flowchart illustrating advertisement schedule management and updating process for an advertisement station according to one or more embodiments;

FIG. 6 is a schematic diagram illustrating an event based advertising method when detecting the presence of an event condition using a camera device according to one or more embodiments;

FIG. 7 is a flowchart illustrating a method of a camera based event-oriented advertisement playing method according to one or more embodiments;

FIG. 8 is a flowchart illustrating a method of sensor device and connected information source based event-oriented advertisement playing method according to one or more embodiments;

FIG. 9 is a schematic diagram illustrating a system for automatic advertisement authorization according to one or more embodiments;

FIG. 10 is a flowchart illustrating a method of automatic advertisement authorization according to one or more embodiments;

FIG. 11 is a schematic diagram illustrating a system for advertisement information inquiry according to one or more embodiments;

FIG. 12 is a flowchart illustrating a method for automatic advertisement information inquiry according to one or more embodiments;

FIG. 13 is a schematic diagram illustrating an intelligent system for automatic advertisement component generations using generator models based on user input pattern according to one or more embodiments;

FIG. 14 is a schematic diagram illustrating a system for automatic advertisement component generation, advertisement synthesis and refinement according to one or more embodiments;

FIG. 15 is a flowchart illustrating a method of advertisement component generation, advertisement synthesis and refinement according to one or more embodiments;

FIG. 16 is a flowchart illustrating a method of advertisement proposal and template generation process according to one or more embodiments;

FIG. 17 is a flowchart illustrating a method of advertisement component and presentation generation process according to one or more embodiments;

### DETAILED DESCRIPTION OF THE INVENTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The present invention discloses an internet of advertisement system that not only enable the public to freely access this system for bringing their advertisement to anywhere they want and anytime they need, but also help the public to automatically generate high quality and professional advertisements based on their provided advertising descriptions and ideas.

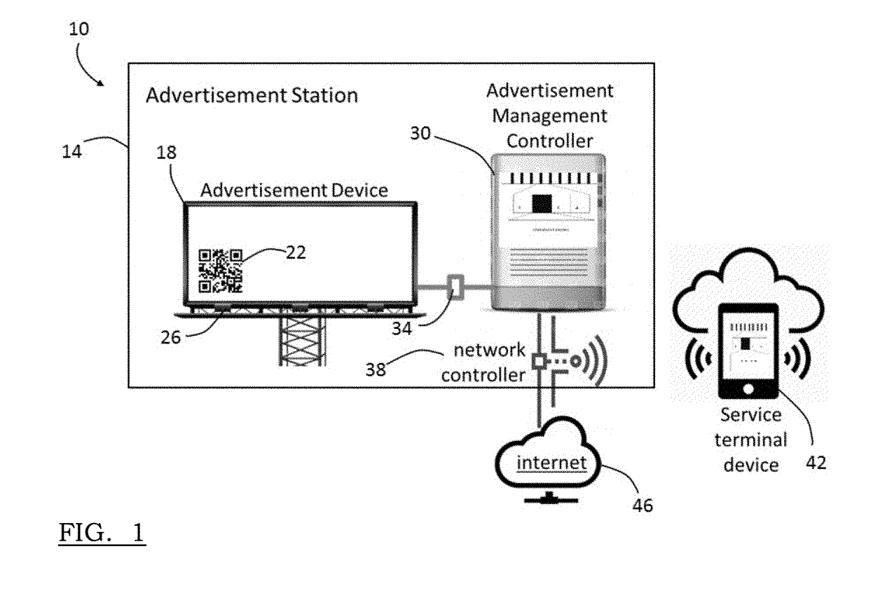

With reference to FIG. 1, a schematic diagram of an internet of advertisement (IoA) system for providing automated advertising services to be shared among public service users using advertisement stations is illustrated according to one or more embodiments and is generally referenced by numeral 10. The service system 10 comprises fundamentally a function unit called advertisement station 14, which is responsible for carrying out the advertising functionality and can be deployed in a distributed manner to many places. An advertisement station 14 further comprises at least one advertisement device 18, an Advertisement Management Controller (AMC) 30, and a network controller 38. An advertisement station has its station ID 22 to identify itself in the IoA system about where it is and what it is, as well as its associated devices, playing methods, advertisement schedule, etc. An exemplary station ID 22 is a barcode attached to an advertisement device 18 or to some other body area of the advertisement station 14. Alternative exemplary embodiments of the station ID 22 include but not limited to series number, location ID, and descriptive name.

The advertisement device 18 has advertising method to play advertisement data, like video, image, audio, lighting, etc. An exemplary embodiment of the advertisement device is a large screen. In some embodiments, the advertisement device 18 comprises additionally accessary devices 26 to extend its advertisement functionality. Exemplary embodiments of the accessory devices 26 and their subsystems include but not limited to image display and displaying control subsystem, video play and playing control subsystem, audio and audio play and channel control subsystem, lighting and lighting pattern control subsystem, haptic and motion control subsystem, image projector and image projecting control subsystem, electro-mechanical equipment and operation subsystem, and service user specified subsystems. An advertisement device 18 may also carry its own device ID to define itself in the IoA system about its station association, property information, functionalities, etc.

The AMC 30 is a computerized device that comprises memory and processor to provide automated and shared advertising functionalities. When a service user is connected, the AMC 30 first obtains from the service user the advertisement station ID 22 to identify the target advertisement station 18 where the service user wants to advertise on. The AMC 30 next loads the present advertisement schedule information of the target advertisement station 14 and display the schedule on a service terminal device 42 of the service user. Exemplary service terminal devices include but not limited to smartphone, tablet computer, laptop and desktop computers. Available advertising time slots, playing methods and plan options are given to the service user for making advertising choices. An advertisement request is then received from the service user after he/she made decision on designed advertising method, advertising time slot and advertising plan that includes playing period, duration and budget. After that, The AMC 30 updates the advertisement schedule for the target advertisement station 14 by incorporating the advertisement request and the advertisement data received from the service user. The AMC 30 communicates with the advertisement device 18 via communication channel/bus 34 and controls the advertisement device 18 to play the user submitted advertisement data based on the updated advertisement schedule and user designed advertising method.

The network controller 38 connects the advertisement station 14 to wired and wireless communication networks. Exemplary wired networks include but not limited to TV cable network, telephone network, ethernet cable network, optical fiber network, etc. Exemplary wireless networks include but not limited to cellular network, WIFI, Bluetooth, radio network, etc. The network controller 38 builds up communication connects between the advertisement station 14 to the rest of the IoA system, the AMC 30, service terminal devices 42. It also provides communication connection to internet, internet connected information database 46, and to higher level advertisement system servers as well as to other advertisement service functionalities. A network controller 38 at an advertisement station is the fundamental access point for service users to get access to the services of the IoA system 10.

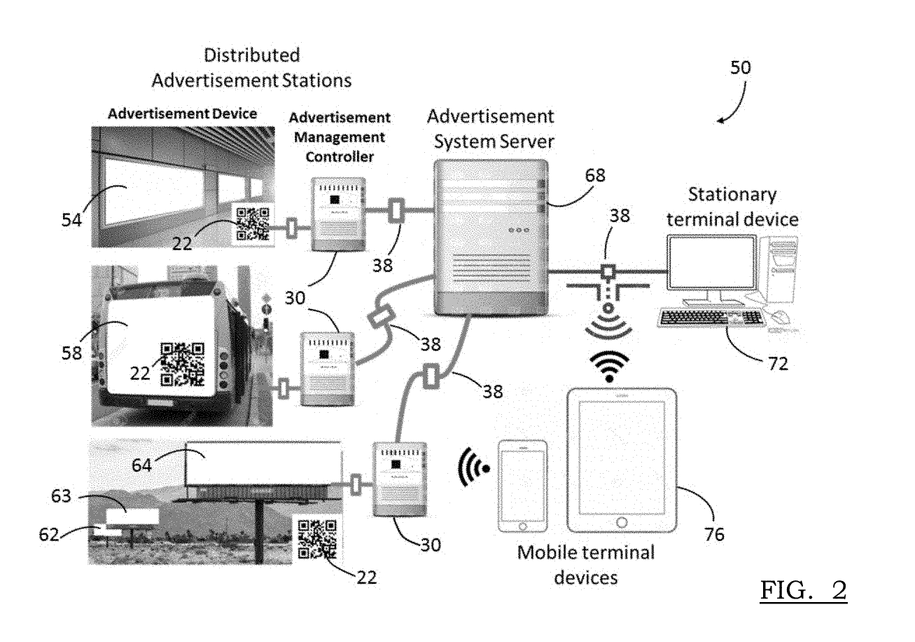

With reference to FIG. 2, a schematic diagram of an automated advertisement system for providing shared advertising services among public service users using distributed advertisement stations and a network based advertisement system server is illustrated according to one or more embodiments and is generally referenced by numeral 50. In this embodiment of the IoA system 10, the advertisement station 14 can be distributed in many different places, in many different manners and on many different objects. The AMCs 30 are now connected via network controllers 38 and communication networks to an advertisement system server 68. The advertisement system server 68 provides higher level advertisement management and controls to a group of distributed advertisement stations 14. At such a higher level of advertisement management and larger scope of advertising accessibility, the advertisement service provided by all the distributed advertisement station 14 can be used by service users both locally and remotely.

Both the network controllers 38 at any of the distributed advertisement stations 14 and the advertisement system server 68 are all access points for service users to access the service of the IoA system 10. An exemplary embodiment of such usage is a service user connect to the advertisement system server via internet from a stationary terminal device 72 to make advertisement request to a distant advertisement station 14. In an alternative embodiment, a service user accesses the advertisement service system 10 using his/her mobile terminal devices 76 via a node of the network controller at one advertisement station 14 to access and make advertisement request to another faraway advertisement station 14.

The advertisement device 18 can be mobile or stationary including but not limited to TV, radio, street furniture, image/video projector, advertising signs, large screen, spectaculars, advertisement boards, billboards, and moving billboards on vehicle, bus, train, etc. A first exemplary embodiment of the advertisement device 18 is a group of large screens 54 installed in a transportation station or shopping center. Each of the large screen 54 has its playing channel and method defined in the AMC 30 for user access and usage. A service user can make choice on one of the large screen to play his/her advertisement data, or make request to a plural of the large screens to generate more attractive advertisement playing formation. An advertisement playing channel for an advertisement device 18 can further be managed by the AMC 30 to be split into many subchannels. In this case, a larger screen can have multiple sub-windows with each of them containing different advertising contents.

In a second exemplary embodiment of the advertisement device 18, the back side of a bus 58 is used for advertising purpose. This bus carried advertisement device 58 is mobile and it can be an electronic advertising device, like large screen or TV, or a regular advertisement picture board. When an electronic advertising device 58 is used with an AMC 30 on the mobile platform, the constructed mobile advertisement station 14 is basically takes the same functionalities as a regular stationary advertisement station 14 with its network controller 38 primarily relying on wireless types of communication channels for advertisement services. A user can access this mobile advertisement station on the bus, at a bus station, or remotely from the advertisement system server 68. When a regular advertisement picture board is used, the AMC 30 will generate an advertisement work order after receiving an approved advertisement request from the advertisement system server 68. The advertisement work order is next assigned to advertising agents, human worker or robots, to place or paint requested advertising contents on the picture board of the advertisement device 58.

In a third exemplary embodiment, the advertisement device 18 comprises a group of billboards, represented as 62, 63 and 64, distributed along sections of transportation highways. Similar to the exemplary large screen devices 54, such billboards can be individually requested for advertising purpose or they can be used in formation groups. Such group of advertisement devices can be managed automatically by AMC 30 for their electronic device components. They can also be served involving manual works for their regular image displaying components. In some embodiments, the advertisement device 18 comprise a mixture of different types of functional advertisement devices. And each of such functional advertisement device may be distributed to different locations. When working together, the mixture of devices type of advertisement device 18 still generate effective advertisement demonstrations. All the different operation methods for advertisement play provided by an advertisement device 18 are registered with the AMC 30 that manages the advertisement device 18. The AMC 30 defines advertisement channel for each of the available operation methods in its advertisement schedule and the AMC 30 can operate to play advertisement data using all the operation methods based on designed advertainment play methods and device activation and operation sequences.

In some embodiments, an advertisement device 18 is extendable and it can be equipped with additional devices to extends its functionality. Both standard extension devices and user specified extension devices are supported by this function. Standard extension devices include but not limited to lighting and lighting pattern control devices, audio and sound effect control devices, speaker and microphone, haptic and motion control devices, image projector and image projecting control devices, electro-mechanical equipment and operation devices. The advertisement device 18 also provide IO device for connecting user specified extension devices. The IO device provides power supply and control communication protocol such that the user specified extension devices can be operated automatically by the AMC 30. Typical user specified extension devices include product demo device, robotic device, vending machine, etc.

In order to use the advertising service, a service user shall first provide advertisement station ID 22 to tell either the AMC 30 or the advertisement system server 68 where to play user's advertisement data. This defines the target advertisement station. There are many methods to help service users to achieve this. When staying close to a target advertisement station, the service user can capture a barcode associated to an advertisement device 18 using his/her terminal device 76 and transmit an identity message containing such barcode information to the AMC 30 that manages the target advertisement station. Alternatively, the service user can capture a barcode associated to the target advertisement station 14 and transmit an identity message to the advertisement system server 68 to specify where to advertising with. The most convenient method is to pair with the network controller 38 of the target advertisement station directly via its wireless network, like Wi-Fi or Bluetooth, using a terminal device 76 like smartphone, tablet computer, etc. In this case, the identity information can be obtained as the wireless network's identity. When a service user accesses the advertisement service remotely from the internet or from an advertisement system server 68, a target advertisement station can also be identified by its location, name or other type of IDs like serials number, sequence number or group ID, etc. Some advertisement station lookup, search and dictionary services are also provided by the advertisement system server 68.

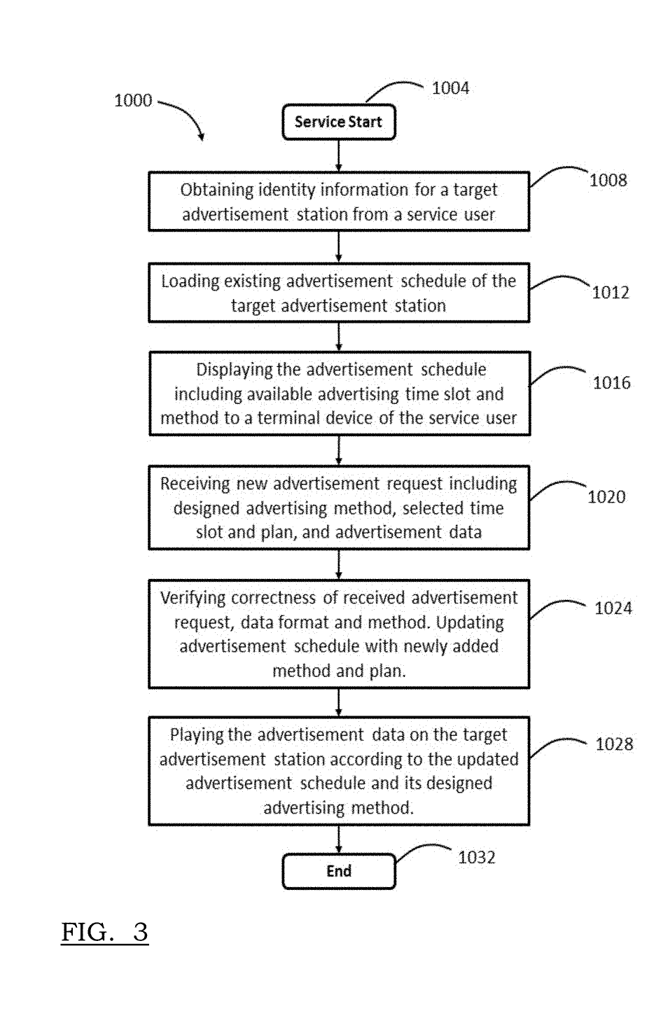

With reference to FIG. 3, a method of the IoA system 10 for providing automated and shared advertising services among public service users is illustrated according to one or more embodiments and is generally referenced by numeral 1000. A service user first quotes the IoA system to find out available advertisement resources including advertising schedule, methods, and budget options. To this end, after service starts at step 1004, the IoA system first obtains from a service terminal device 42 the identify information 22 for a target advertisement station, or a target advertisement device, where a service user wan to advertise with. After identifying the target advertisement station, or device, the IoA system first loads the present advertisement schedule information of the target advertisement station at step 1012 and then communicate to display such schedule on the terminal device 42 of the service user at step 1016. The advertisement schedule is explicitly shown to the user including available and unavailable advertisement time slots, advertisement channels, play cycle, etc. The service user next select an advertising time slot over desired advertisement channel and advertisement playing plan that satisfy his/her advertisement requirements. An advertisement request is then received from the service user at step 1020 after he/she made decision on designed advertising method, advertising time slot and advertising plan that includes playing period, duration and budget. The IoA system further verifies correctness and quality of the advertisement request at step 1024 after receiving the user submitted advisement data. Once validated, the IoA system updates the advertisement schedule for the target advertisement station by incorporating the advertisement request and received advertisement data from the service user. After that, the IoA system finally controls the advertisement device 18 to play the user submitted advertisement data based on the updated advertisement schedule and user designed advertising method at step 1028. The service for this automated advertising process ends at step 1032.

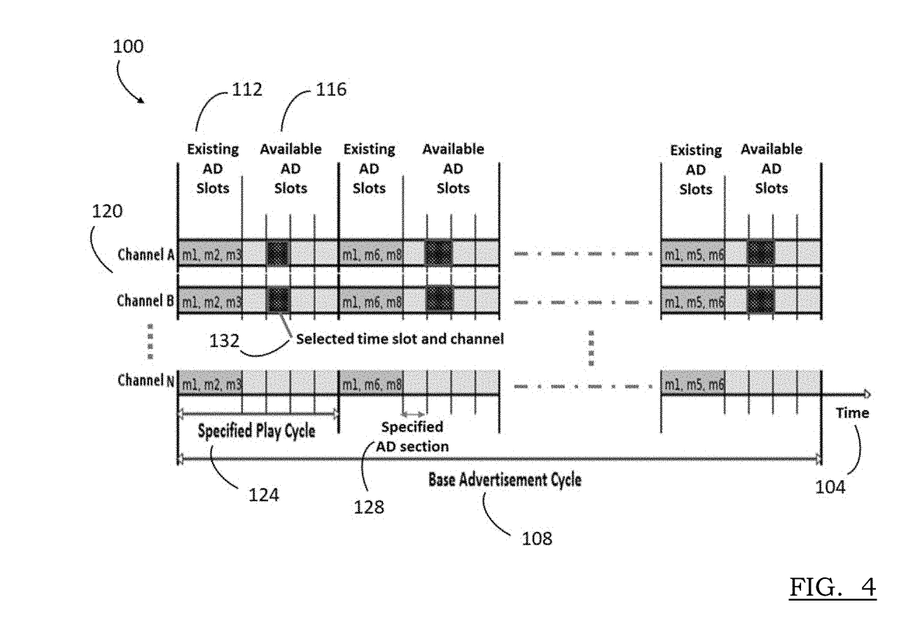

With reference to FIG. 4, a schematic diagram for a method of displaying advertisement schedule and responding to service user's advertisement plan selection is illustrated according to one or more embodiments and is generally referenced by numeral 100. First, along a time axis 104, existing advertisement schedule on an advertisement station 14 is shown on a terminal device 46 with a base advertisement cycle 108. The base advertisement cycle 108 is system selected fundamental cycle that defines the way the IoA system 10 organize recurring advertisement plays. In other words, it is the longest period that the IoA system 10 selected for an advertisement to repeat. Typical embodiments of the base advertisement cycle can be in a certain period of time like several hours, one day, days or weeks, or months, etc.

Besides the base advertisement cycle 108, existing advertisements are further organized in specified play cycle 124. The specified play cycle provides a view on how frequently are different advertisements played with respect to a specified period of time and how are they organize in sequences partitioned by the specified play cycle 124. For example, given the specified play cycle 124 as demonstrated in FIG. 4, advertisement m1 is planned to play in every play cycle, whereas other existing advertisement, like m2, only have its instances once in several specified play cycles 124. In other words, m2 is planned to be played less frequently than m1. Some existing advertisements may not present in the present view of the advertisement schedule because they have much longer play cycle defined by their owner.

A service user can choose a specified play cycle 124, by making it longer or shorter, to meet his/her intended advertisement playing frequency and to have an appropriate schedule viewing mode. User's adjustment on the specified play cycle 124 only change the way how existing advertisements and available advertising time spots are displayed on the terminal device 42, it does not change the schedule of the existing advertisements. After every user adjustment that, advertisement playing sequence is rearranged accordingly such that each of the existing advertisements are allocated inside a certain section along the time line with respect to the new partition of the time line in specified play cycles 124. Before user's adjustment on the specified play cycle 124 is received, the AMC 30 provide a default specified play cycle that is optimized for displaying the schedule of all existing advertisements and the available advertising time for taking new advertisement request.

Within each instance of the specified play cycle 124, the time section is further divided into a segment of existing advertisement slots 112 and another segment of available advertisement slots 116. The segment of existing advertisement slots 112 is blocked out for new user selections, while the segment of available advertisement slots 116 are open for new usage requests. Within the segment of available advertisement slots 116, a service user has the option to adjust the length of a specified advertisement section 128 such that the segment of available advertisement slots 116 are further partitioned into smaller time slots. A service user can thus book one available advertisement time slot that fits his/her advertisement data for advertising purpose. A service user can also make selection on multiple available advertisement time slot at different positions along the advertising sequence within one specified play cycle. The choice of the length of the specified advertisement section is flexible and is not fixed. Many different lengths of sections can be made within the time segment available advertisement slots 116. All the time segment partition operations and time slot rearrangement and selection operations done to one instance of the specified play cycle 124 are automatically applied and repeated to the other instances of the specified play cycles 124 along the time line 104.

On an advertisement schedule view, the time slots are defined across all advertisement channels 120. Each of the advertisement channel corresponds to an advertisement playing method available on an advertisement station 14, like video playing channel, split video playing channel, image displaying channel, audio speaker channel, sound effect channel, microphone channel, lighting and lighting effect channel, projecting channel, electro-mechanical operation channel, user specified operation channel, etc. In an exemplary embodiment, an advertisement schedule view comprises channel A, channel B, to channel N. The service user can make selection on advertising channels available on a target advertisement station 14 to define the designed advertising method. Within each specified play cycle 124, unavailable time slots over advertising channels 120 are blocked out from new requests. A service user can only choose from any of the available time slots over advertising channels 120 for playing newly requested advertisement data. After that, those newly chosen time slots will become unavailable to other service users. In an exemplary embodiment, a service user makes selection at the second advertisement slot inside one instance of the specified play cycle 124 as the selected advertising time slot 132 over advertisement channel A and channel B. The same time slot over the rest of the advertisement channels till channel N are still open to other advertising requests.

When making an advertisement request and planning on advertisement schedule, a service user can further specify properties for the advertisement request including category, theme, target audience, style, format, event triggered advertising conditions, and event-relationship conditions, etc. The position of an advertisement in an advertisement schedule may not be fixed and it can also vary from situation to situation, automatically adjusted by the AMC 30, especially when certain event condition is satisfied or predicted. The content, style and playing method (channel usage) of an advertisement may not be fixed either. Different advertising contents, for example different products, can be used for the same advertisement in the presence of different audience or environmental conditions. Similarly, different advertising style and method can be applied for the same advertisement in accord to the changes of event and environment conditions. For example, sound effect channel may be applied during daytime but it will be muted through night time while an advertisement is continuously played in its scheduled time sequence and frequency.

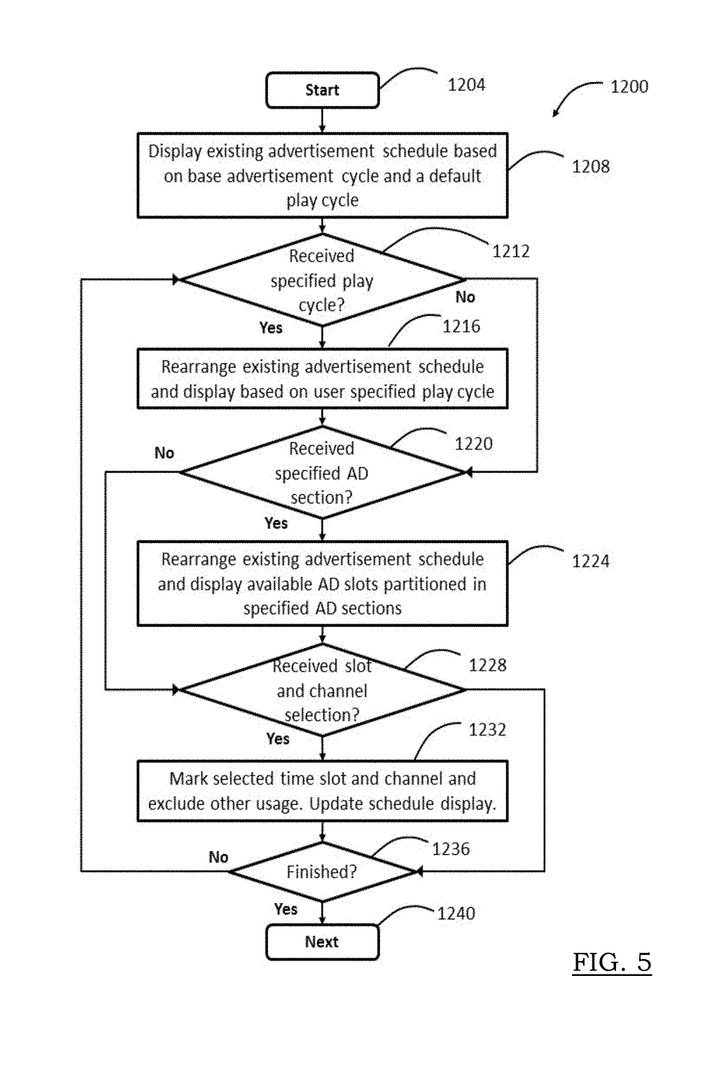

With reference to FIG. 5, a method of advertisement schedule management and updating process for an advertisement station 14 is illustrated according to one or more embodiments and is generally referenced by numeral 1200. After the process starts at step 1204, the method 1200 first generate advertisement schedule view and display present advertisement schedule to user's terminal device 42 using system default based advertisement cycle and a default play cycle at step 1208. If a service user's specified play cycle 124 is received at step 1212, the method 1200 next rearrange existing advertisement schedule according to the user specified play cycle to generate a new advertisement schedule view for displaying at step 1216. Otherwise, the method 1200 goes from step 1212 to step 1220 directly to check if advertisement section specification 128 is received. Once received, the advertisement schedule view is rearranged at step 1224 to display the existing advertisement schedule with available advertisement slots 116 partitioned into advertisement time slots in the length of user specified time section 128. This step is skipped if no such instruction is received. After that, the method 1200 watches on receiving user's advertisement time slot selection over available advertisement channels at 1228. After such selection is made by a service user, the selected advertisement slots over selected advertising channels are marked out from new usage requests from other service users at step 1232. The existing advertisement schedule for an advertisement station is then updated to incorporate the new advertisement request with updated schedule displayed to service users. The operation step from step 1208 to step 1232 are repeated until a service user makes final decision and finishes his/her session of advertisement request at step 1236. The method 1200 is continued with other advertisement service functionalities at step 1240.

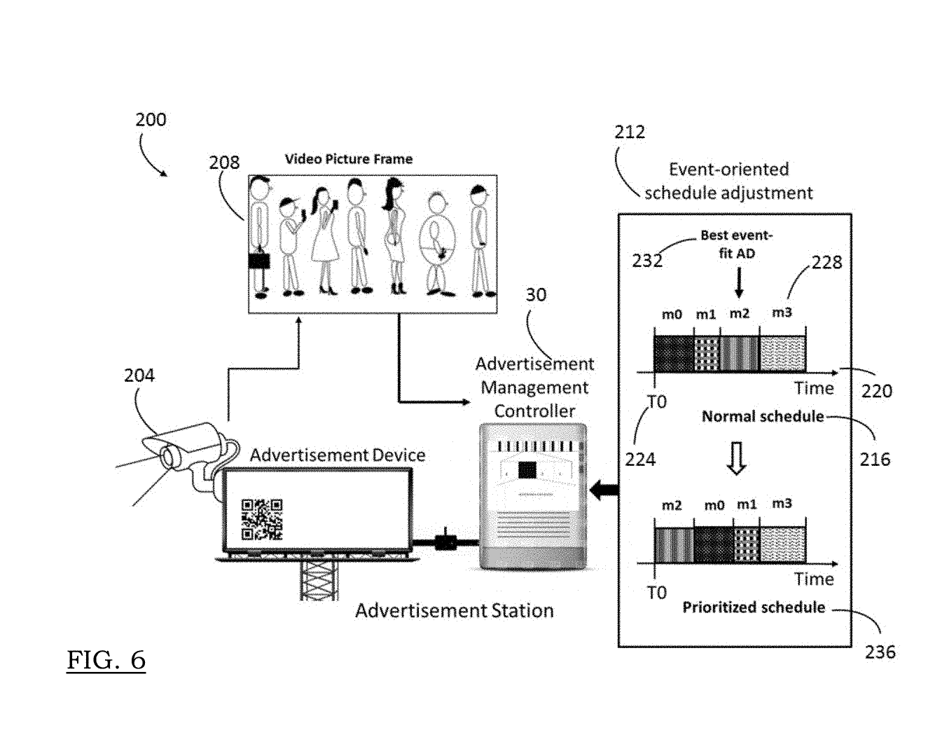

With reference to FIG. 6, a schematic diagram of an event based advertising method for advertisement playing when detecting an event condition using camera device is illustrated according to one or more embodiments and is generally referenced by numeral 200. In this embodiment of the advertisement station 14, at least one of the accessory devices 26 is a camera device 204 for capture surrounding view around the advertisement station in video stream. More than one camera device may be installed at the advertisement station 14 to achieve better view coverage. In this case, after receiving a plural of camera views from camera video streams, object and human detection and tracking can be carried out either in each of the multiple camera view frames, or it can be carried out in a global view by constructively combining all these camera view frames. Computer vision methods, like camera calibrations, image stitching, 3D reconstruction, super resolution, etc., can be used to combine multiple view streams and to improve the view quality of the globally reconstructed scene. In this exemplary illustration, camera 304 captures surrounding scene view 208 that has many people in the video picture frame.

The video stream containing picture frame 208 is transmitted to the AMC 30 to carry out scene analysis and understanding. People are detected as well as their associated objects and other surrounding objects. For each of the people detected in view 208, the AMC 30 carries out people characterization. Characteristics of detected people are first recognized, including age, gender, profession, education, dressing style, belongings, etc. The AMC 30 may further carry out face and gait recognitions to recognize familiar people. The AMC 30 may even carry out pose and gaze estimations to get the posture and gesture information for each person detected in scene, and to determine where are they individual paying attention to. From single view frame as well as across temporal sequence of video frames, the actions and activities, like walk, run, dance, biking, playing, etc., for each of the detected people are also tracked and recognized. Behaviors from single person and group of people are also recognized as well as their activity pose and directions, like walking direction, destination, facing directions, etc. Based on all the above scene understanding information from object detection, background description, and people characterization, event conditions can thus be synthesized through image processing and analysis. Computer vision and machine learning methods are typically used for this purpose. Furthermore, future event conditions can also be predicted based on the observations from the present scene understanding and the present synthesized event conditions.

In this exemplary embodiment illustrated in FIG. 6, event-oriented advertisement prioritization method is used to demonstrate the proposed art of the IoA system 10, where an event-oriented schedule adjustment 212 is carried out in AMC 30 to prioritize certain advertisements that are more interesting either to the majority of the present surrounding crowd or to some people that have potentially high shopping tendency. For the event-oriented schedule adjustment 212, first, statistical analysis is carried out to synthesize and model present event condition based on the identified human characteristics, detected objects and recognized activities. Second, advertisement-audience-relationship is evaluated. Based on such relationship, best-fitting advertisements can be assessed based on their properties like category, theme, target audience, user-specified relationship conditions, etc. Next, a normal advertisement schedule 216 is examined along the time axis 220 at the present time TO 224, where existing advertisements 228, including m0, m1, m2 and m3, are scheduled in subsequent playing queue one after another. Based on the advertisement-audience relationship assessment, advertisement m2 is determined as the best-fitting advertisement 232 with respect to the present event condition. The advertisement schedule is then rearranged to a prioritized schedule 236 by bringing m2 to the up-front of the playing queue. As a result, the advertisement m2 takes the next spot to be played at the advertisement station 14 so that the advertising information can be effectively and timely exposed to its target audience when they are identified near the advertisement station 14.

In an exemplary embodiment of the audience-oriented advertisement playing method, a lady is identified standing next to an advertisement station 14. The AMC 30 of the advertisement station 14 rearrange the advertisement schedule to bring an advertisement of new cosmetic product to the next advertising position in queue to help building up connection between the new cosmetic product and the lady. In a second exemplary embodiment of the audience-oriented advertisement playing method, an athlete playing a basketball is seen in the view next to the advertisement station 14. Through the advertisement-audience relationship assessment, several advertisements are ranked as highly related to the athlete who is playing basketball. The first advertisement is about a new athlete training program. The second advertisement is about a basketball match event. The third advertisement is about a new product of sportswear. All these 3 advertisements are brought up to the front of the advertisement schedule to be played next. Their relationship ranking score determines their relative position in the rearranged playing sequence. The higher the score, the earlier the advertisement will be played next.

In a third exemplary embodiment of the audience-oriented advertisement playing method, a customer is recognized by the AMC 30 in the camera view frame when the customer is walking towards a first advertisement station. This customer had been previously known by a second advertisement station at a different place where the customer had shown interest in shopping for a certain type of fashion. Based on the customer's present walking direction and speed, the AMC 30 predicts on when the customer will come close to the first advertisement station and can pay attention to the advertisement in displaying. Based on this estimated future event condition and the advertisement-audience relationship assessment, an advertisement about a fashion product of similar style is rearranged in the advertisement schedule such that this fashion advertisement will start to play right at the time moment when the customer walks next to the first advertisement station.

Based on an identified event condition, the AMC 30 can also determine the best-fitting advertisement style with respect to certain detected audiences. In this case, some or all of the advertisements can make change on their playing styles to provide the most elegant advertising towards the surrounding audience. For example, an advertisement can change to its cartoon version of advertising style when detecting surrounding kid groups, and it can change to its star-actor version when seeing teenagers are watching the advertisement. The advertisement-audience relationship assessment further evaluates the suitability of advertising contents with respect to audiences. For example, advertisements for adult products are temporarily removed from the advertisement schedule when young kids or teenagers are around an advertisement station 14. Advertisements with violent contents will be played by hiding such contents or by switching to a different version of the designed advertisement data without such violent contents. When detecting old people are around an advertisement station 14, advertisements with strong music and sound effect are modified by AMC 30 such that they are played in reduced volume mode or muted mode to assure comfort of the senior people group.

The event-oriented advertising method can also take advantage of other types of accessory devices 26 to advance the capability of people characterizing, interest extraction, etc. In some embodiments of the method 200, microphones are used at the advertisement station 14. Using natural language processing technologies, additional people characteristic information can be obtained from their dialogue, like dialect, key words, topic, etc. Advertisement prioritization and style selection can be further improved with such information. Certain advertisements can be brought to the front for playing as soon as certain key words or topics are identified from the conversation and they are highly related to the contents of those advertisements. In some other embodiments of the audience-oriented advertisement playing method 200, robots are used to patrol the nearby area of an advertisement station 14 to extend its information collection capability and to provide more interactive information communication with surrounding audience.

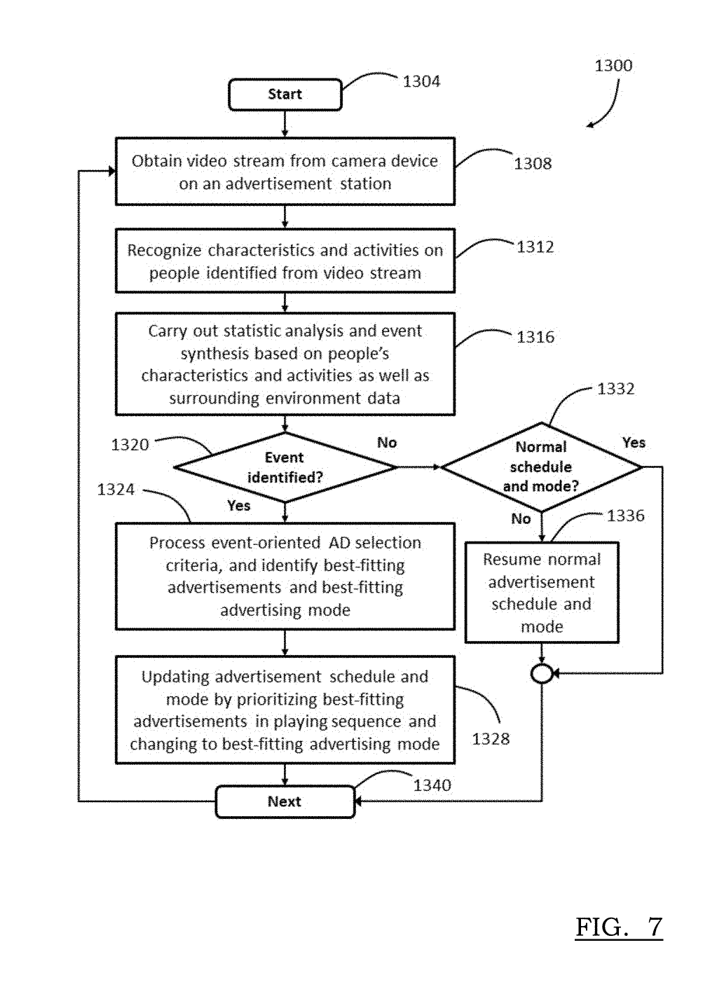

With reference to FIG. 7, a method for audience-oriented advertising using camera device is illustrated according to one or more embodiments and is generally referenced by numeral 1300. After start at step 1304, the AMC 30 at an advertisement station 14 first obtains video stream from at least one camera device 204. It then detects and tracks objects and human in the video stream at step 1312 and recognize human characteristics for each person identified nearby or in crowds. The AMC 30 further recognizes human activities as well as estimates their motion parameters. Statistical analysis is then carried out at step 1316 to synthesize and model present event condition based on the identified human characteristics, detected objects and recognized activities. Future event conditions can also be predicted based on the present surrounding observations over object and people with respect to their characteristics, attention and behaviors. Surrounding environment data from an advertisement information system can also be used to assist the statistical analysis. If an event is identified at step 1320, the AMC 30 next evaluates the advertisement-audience-relationship at step 1324. Based on such relationship, best-fitting advertisements can be assessed based on their properties like category, theme, target audience, user-specified relationship conditions, etc. Best-fitting advertisement modes can also be inferred from such relationship assessment. Such advertisement modes cover advertising style, advertisement content suitability assessments, advertisement playing method appropriateness evaluations, etc. The advertisement schedule 216 at the advertisement station 14 is updated at step 1328 by make arrangement on playing sequence, frequency and group, etc. These best-fitting advertisements can be prioritized in the advertisement playing sequence to maximize its interest toward the identified crowds, or they can be rearranged in playing sequence to meet audiences who are coming towards the advertisement station in the near future. Some or all of the advertisements can make change on their playing styles to provide the most attractive advertising effects. Some or all of the advertisements can change or hide some contents that are regarded inappropriate to audience groups. Some of the advertisements can be stopped in playing due to inappropriate contents with respect to observed audience group. And they can be resumed in playing until such audience group are no longer presented nearby. If no event is identified at step 1320, method 1300 checks on if the normal advertisement schedule 216 and mode are taking effect at step 1332. If not, advertisement schedule resumes back to its normal schedule 216 and advertisement mode resumes back to its normal mode at step 1336. The present loop of method 1300 summarize at step 1340. After going to the next step at 1340, operations from step 1308 to step 1340 repeat to keep identifying event condition and to carry out audience-oriented advertisement playing.

In some embodiments of the event-oriented advertising method, environment-oriented advertisement method is implemented to achieve environment awareness advertisement schedule rearrangement and mode selection by detecting the presence of certain environmental event conditions and by predicting future environmental event conditions. An advertisement station 14 have surrounding sensing sensors installed to measure the time, location and environmental conditions around. Exemplary sensors include but not limited to camera, temperature sensor, humidity sensor, sound and voice sensor, pressure sensor, light sensor, smell sensor, laser scanner, sonar, radar, GPS, etc. The advertisement station 14 can further have connected information resource from internet and from the rest of IoA system. Such connected information resources include but not limited to cloud based information system, geological information system, transportation information system, weather information system, map information system, news information center, time server, etc.

In a first exemplary embodiment, an advertisement station 14 is an outdoor advertisement TV stand on a street. After recognizing it is raining, TV commercials for umbrella and rain coat from local stores are ranked high through advertisement-environment relationship assessment and they are prioritized in the advertisement schedule to be played at up-front sequence and at a higher advertisement playing frequency. In some cases, such TV commercials might not even be scheduled in normal advertisement schedule. They are only loaded for playing when certain environment conditions are satisfied. In some other cases, the advertisements are in normal advertisement schedule but their advertising content can be changed in accord to the variations of the identified surrounding event and environment conditions.

In a second exemplary embodiment, an advertisement station 14 on a street can automatically control the volume of its speaker device at different time and at different surrounding noise level. The advertisement station 14 may mute the speaker channel but keep the video advertisement playing channel when the surrounding noise level is low at early morning. It can increase the speaker volume during day time when the surrounding noise level become high or when a camera sees crowds nearby. A video playing channel of the advertisement station 14 can also be dimed or enlighten according to different surrounding lighting conditions.

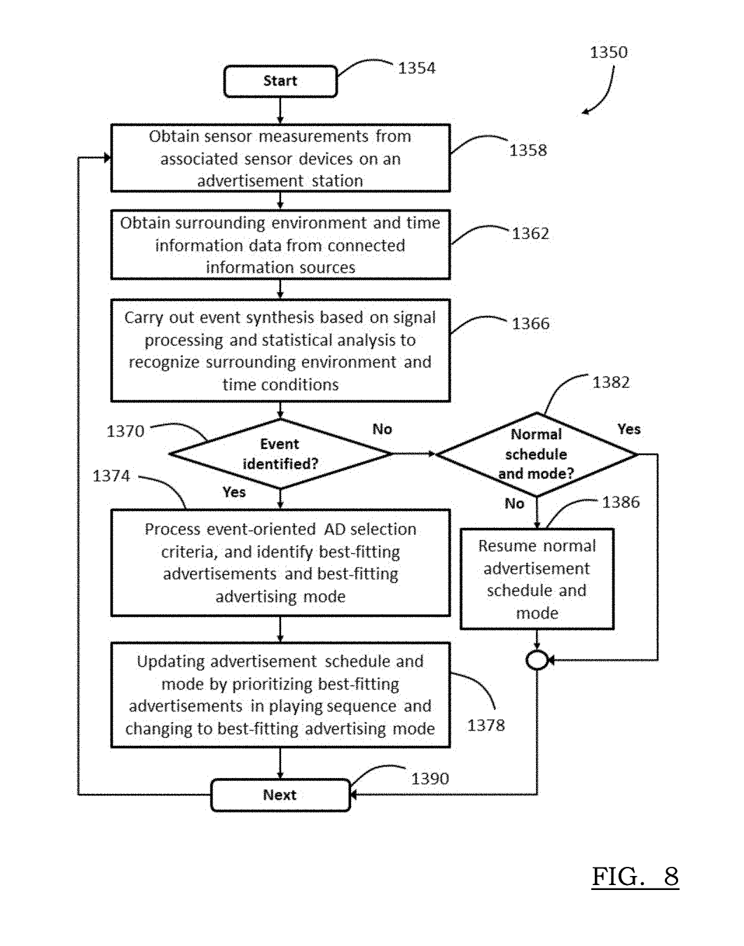

With reference to FIG. 8, a method for environment-oriented advertising using accessory sensor devices and connected information resources is illustrated according to one or more embodiments and is generally referenced by numeral 1350. After service starts at step 1354, the AMC 30 first obtains measurement data from associated sensors installed on an advertisement station 14 at step 1358. Additional environmental and time information can also be obtained from connected information sources at step 1362. Next, signal processing and information fusion are carried out at step 1366 to recognize surrounding environment conditions, including time, weather, crowd, noise, lighting, color, etc., in order to synthesize and model a present environmental event condition. Future environmental conditions can also be predicted based on the present measurement and information collected to model a future environmental event condition. If an event is identified at step 1370, the AMC 30 next evaluates the advertisement-environment-relationship at step 1374. Based on such relationship, advertisement schedule and mode at an advertisement station 14 can be changed to provide most environmental friendly and attractive advertising. First, best-fitting advertisements can be identified through advertisement-environment relationship assessment and they can be prioritized in advertisement playing by make rearrangement on the sequence and frequency of the existing advertisement schedule. Such advertisement schedule rearrangement can also be made such that the best-fitting advertisements meet the predicted occurrence of future environmental event conditions. Second, best-fitting playing style, method and content can also be assessed with respect to advertisement-environment relationship and the environment event conditions. All or some of the advertisements can make change to their style, playing method, as well as contents, to provide most effective and friendly advertising in the presence of identified environmental event conditions. Advertisement contents and certain advertisement may also be stopped in playing if they are regarded as inappropriate with respect to the identified environmental event conditions. The advertisement schedule 216 and mode at the advertisement station 14 is updated at step 1378. If no event is identified at step 1370, method 1350 checks at step 1382 on if the normal advertisement schedule 216 and mode are effective. If not, the environment-oriented advertisement schedule resumes back to its normal schedule 216 and mode at step 1386. The present loop of method 1350 summarize at step 1390. After going to the next step at 1390, operations from step 1358 to step 1390 repeat to identify environmental event conditions and to carry out environment-oriented advertising continuously.

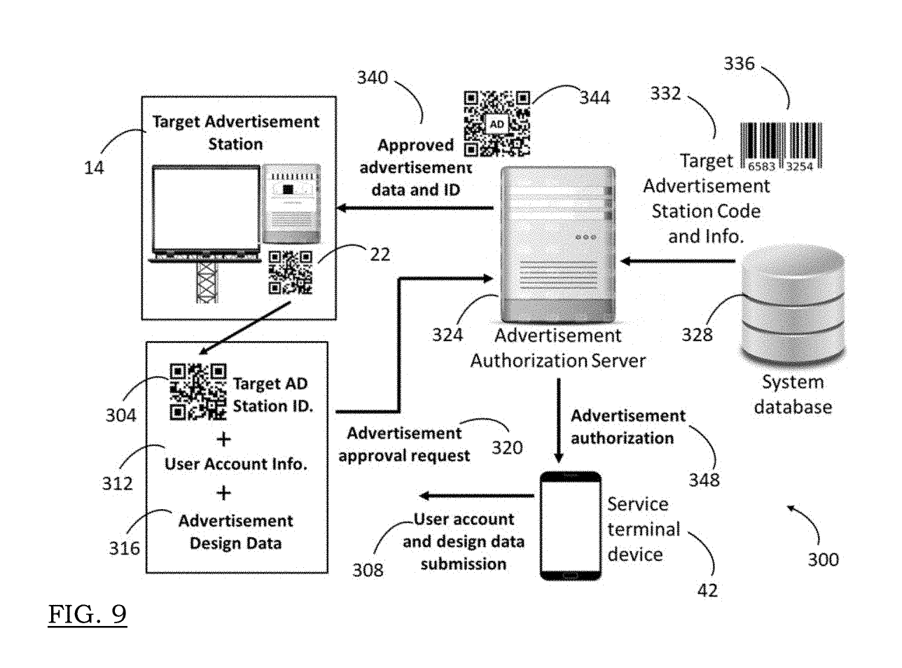

While providing the convenience of advertising freely with advertisement resources open to public users, it is equally important to assure sufficiently high quality of the advertisements and adequate health of the advertisement ecosystem. To this end, advertisement idea and data from service users are necessarily examined by the IoA system 10 before they can be authorized and deployed to an advertisement station 14. With reference to FIG. 9, a schematic diagram of the method for automatic advertisement authorization is illustrated according to one or more embodiments and is generally referenced by numerical 300. In order to obtain advertisement authorization, a service user first login to service to submit user account information and user designed advertisement data 308. The service user next captures the ID information 22 of a target advertisement station 14. The captured target advertisement station ID 304, user account information 312 and the user designed advertisement data 316 are packed into an advertisement approval request 320 at a terminal device 42 of the service user. The service user next submits the advertisement approval request 320 to an advertisement authorization server 324 via communication networks. The advertisement authorization server 324 reviews the submitted advertisement data by examining their attributes against a set of advertisement content and quality criteria. Exemplary attributes include but not limited to idea, contents, authenticity, advertisement playing methods, style, scheme, length, format, etc. An advertisement authorization request can also be made for advertising with a group of advertisement stations.

The authorization result 348 is then communicated back to service user's terminal device 42. For authorized advertisement data, the advertisement authorization server 324 further retrieves station code 332 and station information from a system database 328. Such station code 332 is internally property shared within the IoA system. And it is not open to any of the service users. An advertisement station will only accept advertisement request when the received advertisement data contain correct station code corresponding to this advertisement station. Such an encoding method guarantees the authority of IoA authorization and the centralized management of the advertising resources. An exemplary instance of the station code 332 is a series code 336. Other types of machine coding methods can also be used alternatively. The advertisement authorization server next generates approved advertisement data 340 with a given advertisement ID 344. The advertisement ID 344 provides the authorized advertisement a unique identity in the advertisement system. The approved advertisement data 340 embeds the station code 332 such that it can be recognized by a target advertisement station 14 and it can be accepted for deployment at the station. After the authorization, the approved advertisement data 340 can be deployed to the target advertisement station 14 specified by the service user directly. Once received, the advertisement schedule at the target advertisement station 14 will be updated by incorporating the new advertisement data and user specified playing plan. Alternatively, the advertisement authorization 348 can be communicated back to the service user on the service terminal device 42. Such advertisement authorization 348 contains approved advertisement data and ID 340. A service user can choose to make the submission to a target advertisement directly or through the advertisement authorization server at a later time.

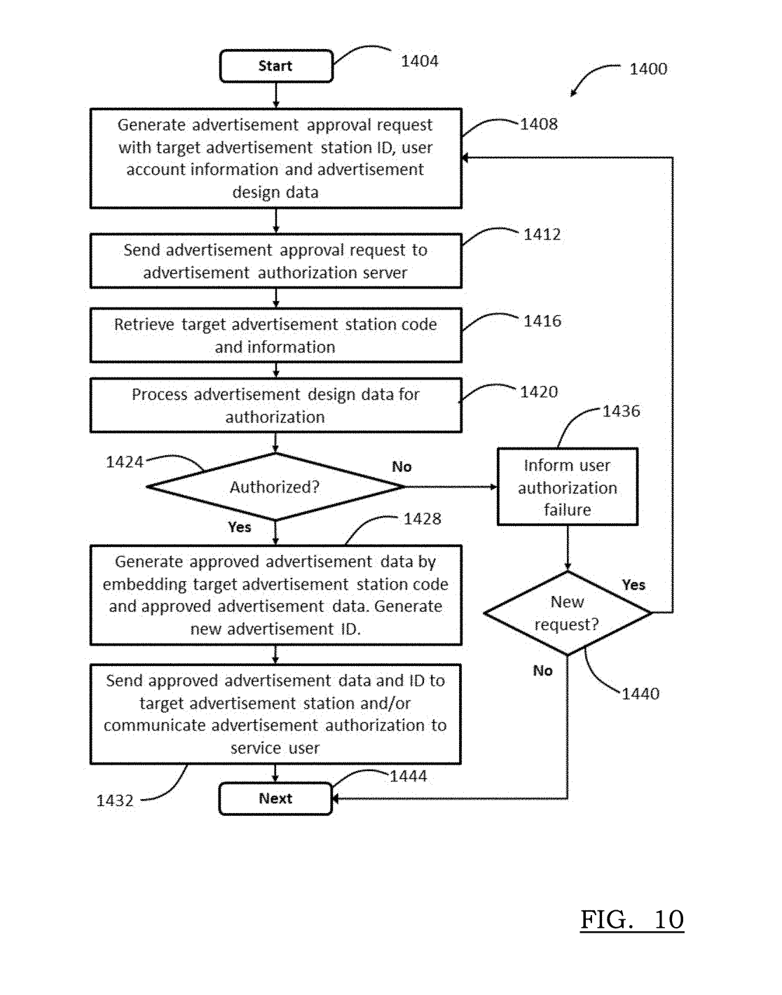

With reference to FIG. 10, a method for automatic advertisement authorization is illustrated according to one or more embodiments and is generally referenced by numeral 1400. After starts at step 1404, advertisement approval request 320 is first generated at a service user's terminal device at step 1408. Such request contains target advertisement station ID, user account information and raw advertisement data. The approval request is next submitted at step 1412 to the advertisement authorization server 324. Based on the target advertisement station ID, station code 332 of the target advertisement station is retrieved from an advertisement system database 328 at step 1416. Next, user submitted raw advertisement data are processed with reviewing functions on attributes including content, format, quality, etc. at step 1420. The advertisement approval request can be approved by satisfying a set of advertising criteria. Such criteria satisfaction evaluations are made automatically by computer program functions in the advertisement authorization server 324. If the request 320 is approved at step 1424, advertisement data is generated from the raw advertisement data together with an authorized advertisement ID and embedded target advertisement station code 332 at step 1428. The advertisement authorization is then communicated back to the service user at step 1432. The advertisement data is readily deployable to be played at the target advertisement station 14. Such advertisement data can either be assigned directly to the target advertisement station 14 given the service user's advertisement request is ready. Alternatively, the advertisement data is transmitted to the terminal device of the service user for afterwards advertisement request and submission. On the other hand, if the authorization fails at step 1424, the service user will be informed at step 1436. At step 1440, the method 1400 checks if the service user want to improve the advertisement data and submit a new advertisement approval request 320. If yes, the process repeats by going back to step 1408. Otherwise, the method concludes at step 1444 and it is next followed by other advertising services provided by the advertisement system.

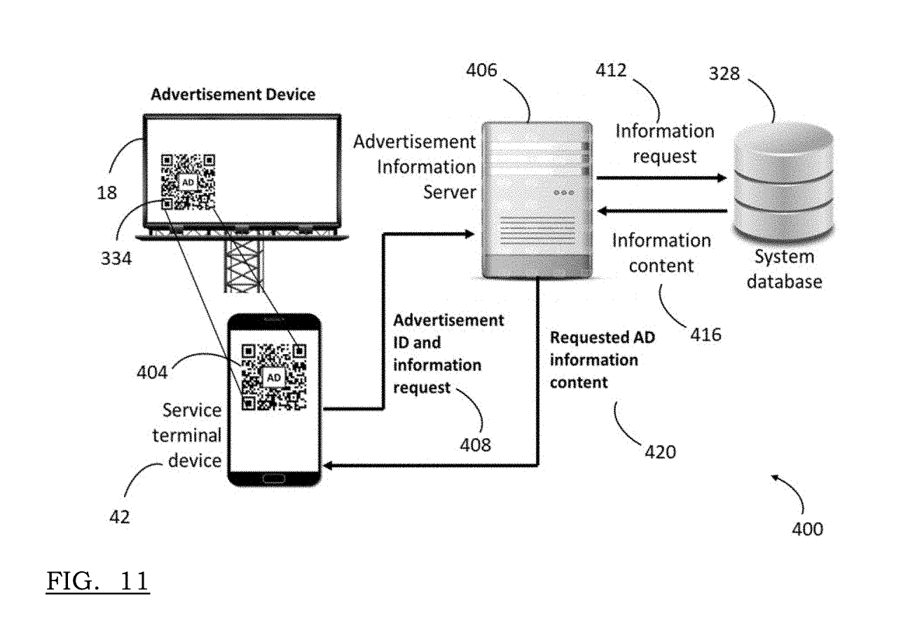

Another important aspect of the IoA system 10 is its advertisement information inquiry service. Service users can query the system at an advertisement station or from a service terminal device to get additional information about an interesting advertisement, or about something that has not even been advertised. With reference to FIG. 11, a schematic diagram for a system providing service of advertisement information inquiry is illustrated according to one or more embodiments and is generally referenced by numeral 400. In this exemplary embodiment, an advertisement is played on a large screen type of advertisement device 18 with its advertisement ID 334 displayed on the screen. A service user captures an image 404 of the advertisement ID 334 on a service terminal device 42. By sending an advertisement ID and information request 408 to an advertisement information server 406, the service user is interested in this advertisement and would like to query further information about the advertised event, product or other information related to this advertisement. The advertisement information server 406 next send information request 412 to a system database 328 to retrieve stored information related to the queried advertisement based on it advertisement ID 334. Additional information may also be obtained from extended internet based information resources. In some embodiment of the system, the advertisement information server can even connect to the advertisement provider for answers to user's information inquiry. Direct connection between the service users can also be established by providing permitted contact information. After obtaining the information content 416, the advertisement information server 406 responses to the service user's information request 408 by sending back request advertisement information content 420 to the terminal device 42 of the service user.

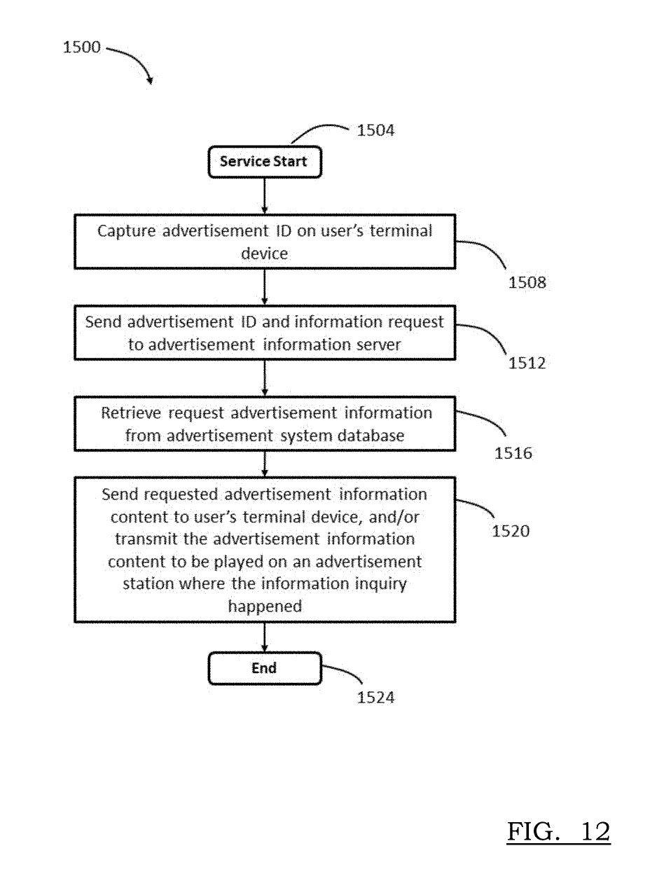

With reference to FIG. 12, a method for automatic advertisement information inquiry is illustrated according to one or more embodiments and is generally referenced by numeral 1500. After service starts at step 1504, an advertisement ID 334 is first captured on a user's terminal device to identify the topic of this information inquiry. The inquired advertisement ID 334 information is recognized from a user's advertisement inquiry message. Such advertisement inquiry message can be in the format of voice record, image, photo, etc. Accordingly, the advertisement ID 334 can either be a barcode, series number, an advertising picture, a sentence containing key words, or a voice record while the user talked about what is needed. Additional questions can also be input to the user's terminal device and added to the information request message. When the advertisement information server 406 receives advertisement inquiry from a service user at step 1512, it visits the advertisement system database 328 at step 1516 with the advertisement ID 334. Best-matching advertisement information will be retrieved from an advertisement information database. Next, the advertisement information server 406 replies with inquired information about the advertised topic to help the service user finding more on his/her interested event, product or topics at step 1520. Such best-matching advertisement information can also be transmitted to an advertisement station where the advertisement inquiry happens. When none best-matching is available, the advertisement searching result is still reported back to the service use to inform him/her about the status. When insufficient information is available, the advertisement information server 406 can extend its search to connected internet information sources. It can also help the user inquiring information to connect to the advertisement provider directly for more specific inquiries.

For publics, professional advertisement design and data generation are art work and are expensive. For people with no advertisement design knowledge or experience, the IoA system provides Do-it-yourself service with interactive advertisement design tools to help users achieving high quality and fascinating advertisement outline, configuration and beautification with only inputs from users like descriptive words, sentences, sketches of drawing ideas, raw advertising materials, etc. A professional advertisement design becomes as simple as designing a set of presentation slides. All these amazing works from the IoA system are achieved by an advertisement design server with its computer vision, image processing, natural languish processing, and machine learning tools.

The advertisement designer server comprises many different types of generative models that “translating” any forms of user inputs into a corresponding advertisement component in user intended target advertising format. Generative models use supervised and unsupervised machine learning techniques to automatically generate advertisement components. Exemplary generative models include but not limited to generative adversarial networks (GANs), variational autoencoders, autoregressive models, and reinforcement learning models. Generative models can learn to create data that is similar to data that human experts produce.

In an exemplary embodiment of the generative models, GANs are used. GANs are a class of artificial intelligence algorithm used in unsupervised machine learning, implemented by a system of two neural networks contesting with each other in a zero-sum game framework. This technique can generate photographs that look authentic to human observers and learn codes that contain valuable information about the textures. The main idea behind a GAN is to have two competing neural network models, a generative network and a discriminative network. The discriminative network learns a function that maps the input data (x) to some desired output class label (y). In probabilistic terms, they directly learn the conditional distribution P(y|x). The generative network tries to learn the joint probability of the input data and labels simultaneously, i.e. P(x,y). This can be converted to P(y|x) for classification via Bayes rule, but the generative ability could be used for something else as well, such as creating likely new (x, y) samples.

The generative network learns to map from a latent space to a particular data distribution of interest, while the discriminative network discriminates between instances from the true data distribution and candidates produced by the generator. The generative network takes user input data and generates samples (and so is called the generator). The discriminative network (called the discriminator) receives samples from both the generator and the training data, and has to be able to distinguish between the two sources. These two networks play a continuous game, where the generator is learning to produce more and more realistic samples, and the discriminator is learning to get better and better at distinguishing generated data from real data. These two networks are trained simultaneously, and the hope is that the competition will drive the generated samples to be indistinguishable from real data. Both types of models are useful, but generative models have one interesting advantage over discriminative models—they have the potential to understand and explain the underlying structure of the input data even when there are no labels. This is very desirable when working on advertisement data generation problems in the real world.

Without loss of generality, an image component generation model is used as an exemplary embodiment for illustrating the method of automatic advertisement component generation. In this case, an advertisement image is created using GANs or conditional GANs (cGANs). An automatic advertisement image generation is defined as input-to-image translation that translating one possible description of a scene into an image representation. For example, after the image component generation engine is loaded, a triangle draw by user can be translated into a hill, green sketches over an area can paint grassland on the image, etc. For another example, when user inputs description sentence “bus station with many people” at a certain image area, a picture of bus station with people standing next to it is then automatically added on the image at corresponding image location. With the automatic advertisement component generation engine, service users without any experience in art or artistic design can still achieve professional and high-quality advertisement design and refinements. Furthermore, time consuming drawing and coloring works, as well and styling and theme optimizations, can be done by intelligent computer programs.

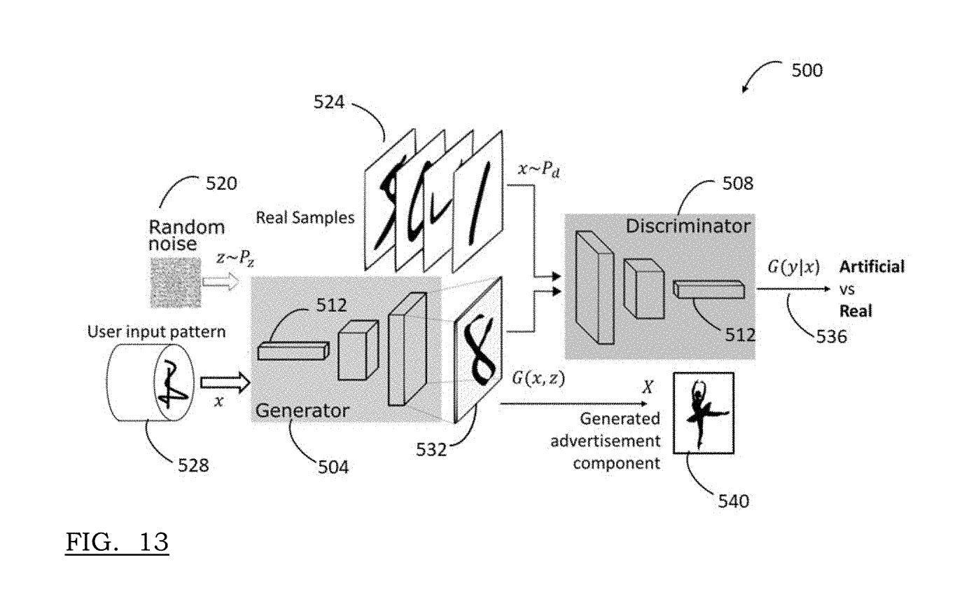

With reference to FIG. 13, a schematic diagram for a generative model that generates advertisement component is illustrated according to one or more embodiments and is generally referenced by numeral 500. The generative model 500 takes a user input pattern 528 under random noise 520 and tries to generate a sample of data 532 using a generative network 504 that comprising network components 512. Exemplary embodiments of the network component 512 include but not limited to convolutional neural network, recursive neural network and fully-connected neural networks. The generated data G(x,z) is then fed into a discriminator network 508. The task of Discriminator Network 508 is to take input either from the real data 524 or from the generator output 532 and try to predict whether the input is real or generated at its output G(y|x) 536. The real data 524 contains professional advertisement component made by human design experts and artists and they are used to train the generative model 500. Through sufficient training and competition between the generator 504 and the discriminator 508, the generator 504 becomes more and more professional in generating desired advertisement component data 532 that is regarded by the discriminator as indistinguishable from human expert produced advertisement components. After training, the design output 540 from the generator 504 starts serving as the generated advertisement components to service users. Furthermore, the generator network 500 can take much broader scope and format of user input pattern 528 than the set of user input patterns used in the training phase.

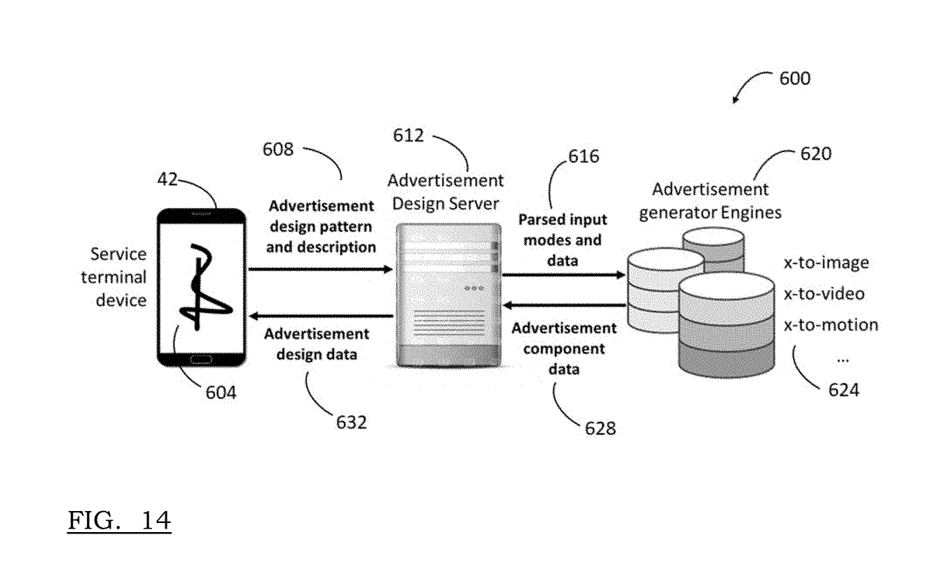

With reference to FIG. 14, a schematic diagram of a system for automatic advertisement component generation, advertisement synthesis and refinement is illustrated according to one or more embodiments and is generally referenced by numeral 600. In this exemplary embodiment, an advertisement design server 612 connects to many advertisement generator engines 620. Each of the generator engine 620 contains a type of the generator model 500 as a x-to-y engine and it is responsible for translating a certain type of user input pattern data x to a type of advertisement component y. Exemplary embodiments 624 of such generator engines 620 include but not limited to x-to-image engine, x-to-video engine, x-to-motion engine, etc. Exemplary embodiments of user input pattern data include but not limited to sketch, drawing, words, sentence, image, video, audio record, reference advertisement components, etc. In a first exemplary embodiment of the x-to-y engine is a text-to-image engine that takes user descriptive words input about image items and their spatial relationship to produce a near photo picture result that satisfies the user's design descriptions. In a second exemplary embodiment of the x-to-y engine is a reference-to-video engine that takes an existing advertisement provided by service user as reference to generate a new advertisement in similar scene and theme, but with newly user's specified contents and styles.

To use the advertisement generation service, a user first inputs pattern data 604 on a terminal device 42, and then transmit advertisement design pattern and description 608 to the advertisement design server 612. Based on the format and content of the received pattern data, the user input pattern and description data 608 are parsed into input modes and data corresponding to each available x-to-y component generation engine 624 on the advertisement generator engines 620. The generated advertisement components 628 in accord to the parsed input mode and data 616 are then sent back to the advertisement design server 612 for further refinement and formatting. After packaging such advertisement component data to advertisement proposal and template, the advertisement design data 632 can be finalized and provided back to the service user.

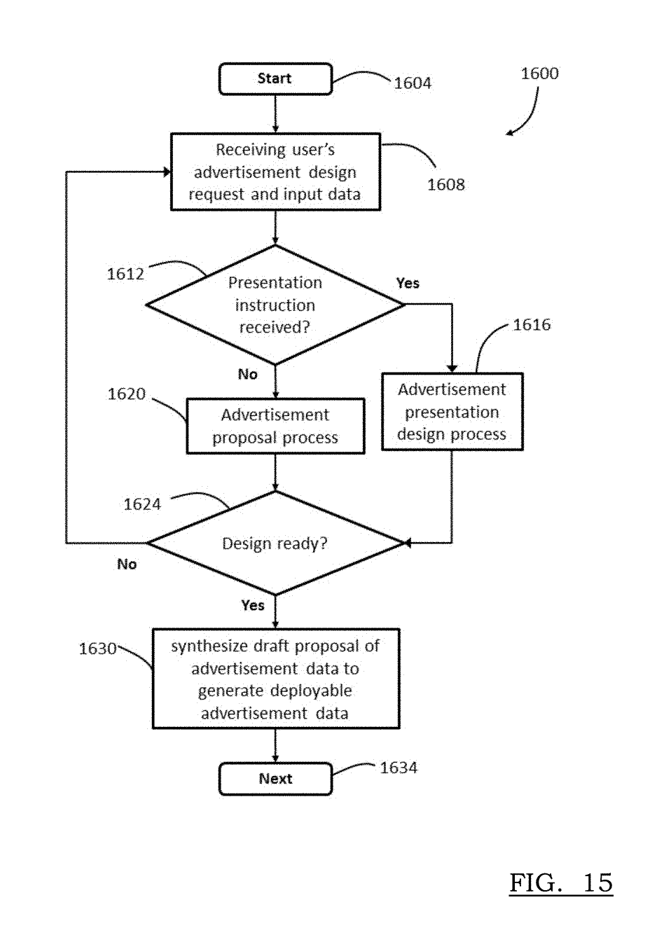

With reference to FIG. 15, a method for advertisement component generation, advertisement synthesis and refinement is illustrated according to one or more embodiments and is generally referenced by numeral 1600. After starts at step 1604, the advertisement generation server 612 waits for receiving advertisement design request and other types of user inputs at step 1608. Once received, the method 1600 checks if the received user input is a specification instruction or a presentation instruction at step 1612. Specification instructions include but not limited to configuration and description to setup how the advertisement materials and components are organized as well as the general style and theme. Presentation instructions are related to design tools for advertisement component generation. When detecting a presentation instruction for component design or scene arrangement at step 1616, the advertisement design server 612 starts advertisement presentation design process 1616, where the automatic advertisement component generation system 600 with generative models 500 are used to carry out advertisement component generation, arrangement and multimodal scene production.

On the other hand, when a specification instruction is received at step 1612, the advertisement design server 612 generates a draft advertising proposal including specified advertisement template and format, presentation organization, candidate playing methods and style at step 1620. Before the user finishes the advertisement design, process from step 1608 to step 1624 are repeated and continued. Once confirmed from user the present advertisement design is ready at step 1624, the draft proposal and user designed advertisement components are synthesized to generate advertisement data that are deployable at a target advertisement station at step 1630. The method 1600 will then continue with other process at 1634.

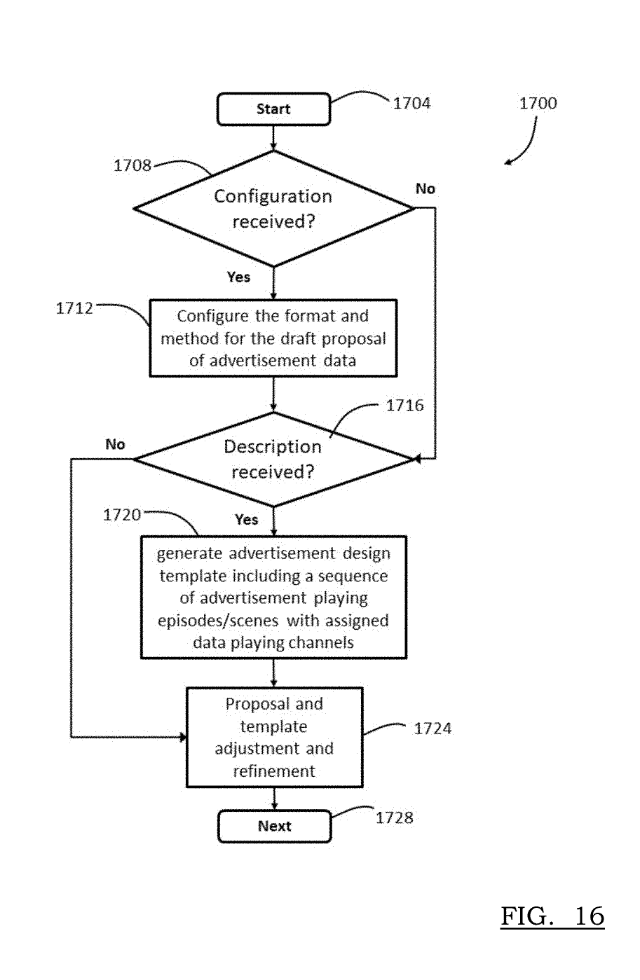

With reference to FIG. 16, a method for advertisement proposal and template generation is illustrated according to one or more embodiments and is generally referenced by numeral 1700. After starts at step 1704, the advertisement generation server 612 checks to see if a configuration command is contained in the received instruction at step 1708. A configuration command instructs the advertisement design server 612 at step 1712 to configure the general outline of the advertisement presentation including but not limited to play methods and parameters, format and theme, scene style, etc. If the received instruction contains a description command at step 1716, it guides the advertisement design server 612 at step 1720 to generate an advertisement design template that includes but not limited to a sequence of advertisement playing episodes and/or scenes with playing methods planed for each of them. A draft advertisement design can be finished and ready for final polish after fill in advertisement components to the design template. The draft proposal of advertisement can be instructed with other specification instructions to take additional adjustment and refinement at step 1724. And then the method 1700 continues to other processing functions at step 1728.

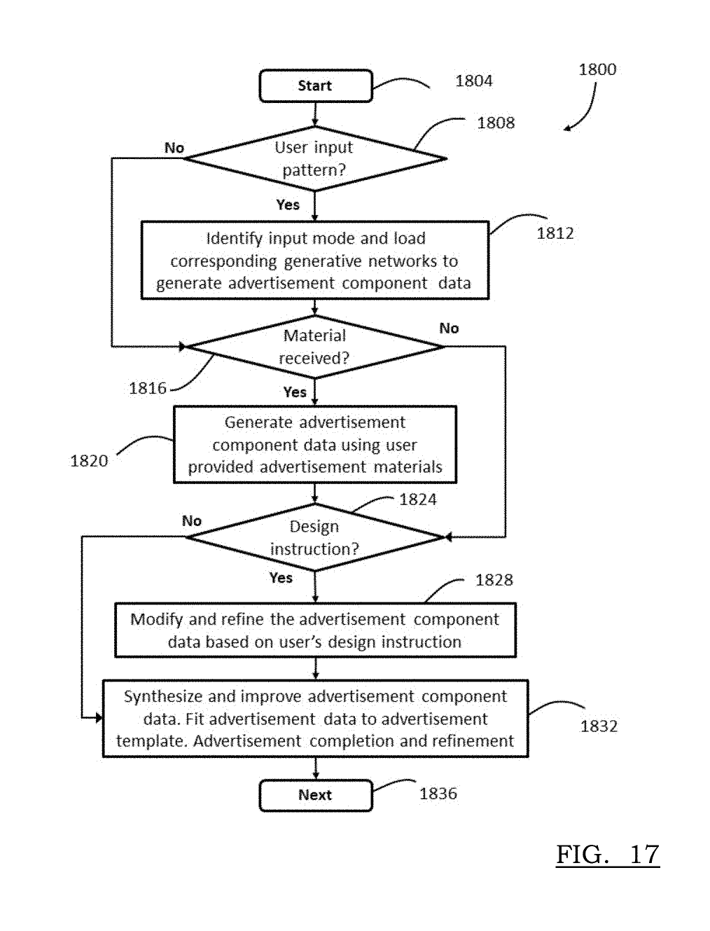

With reference to FIG. 17, a method for advertisement component and presentation generation is illustrated according to one or more embodiments and is generally referenced by numeral 1800. After starts at step 1704, the advertisement generation server 612 checks to see if a user input pattern is received. A received user input pattern then guides the advertisement design server 612 to parse input mode and to load corresponding x-to-y engine 624 to process user input data and to generate advertisement element for component construction at step 1812. The method 1800 next check if user supplied advertisement materials at step 1816. A user supplied material typically includes but not limited to word descriptions, draft image or videos, audio records, reference advertisements, etc. Such user provided advertisement materials can then be processed and modified to generate high-quality advertisement items to fit into new advertisement component template at step 1820. After this, the method 1800 checks if design instruction is received at step 1824. User specified design instructions are used by the advertisement design server 612 to modify and refine the advertisement element data for component generation at 1828. Advertisement component completion and refinement are carried next at step 1832. The method 1800 continues to other processing function at step 1836.

As demonstrated by the embodiments described above, the methods and systems of the present invention provide advantages over the prior art by networking advertisement playing device with advertisement management systems. The resulted internet of advertisement system is able to provide applications enabling future advertising in public easier and more accessible. It can be more focused on peoples' need locally and appropriately in time. It becomes part of the sharing economy in the advertisement sector. Less maintenance is expected. Expensive and time-consuming advertisement designs can now be avoided while high quality advertisement design can still be achieved using computer systems and artificial intelligence. As such, advertising cost can be largely reduced while an advertising process is much more effective and efficient. Future advertisement experiences become friendly and happy. And it can be imagined that people start advertising using their smartphone and computer at home, in office, on the street, or just by standing next to an advertisement station.

While the best mode has been described in detail, those familiar with the art will recognize various alternative designs and embodiments within the scope of the following claims. Additionally, the features of various implementing embodiments may be combined to form further embodiments of the invention. While various embodiments may have been described as providing advantages or being preferred over other embodiments or prior art implementations with respect to one or more desired characteristics, those of ordinary skill in the art will recognize that one or more features or characteristics may be compromised to achieve desired system attributes, which depend on the specific application and implementation. These attributes may include, but are not limited to: cost, strength, durability, life cycle cost, marketability, appearance, packaging, size, serviceability, weight, manufacturability, ease of assembly, etc. The embodiments described herein that are described as less desirable than other embodiments or prior art implementations with respect to one or more characteristics are not outside the scope of the disclosure and may be desirable for particular applications. Additionally, the features of various implementing embodiments may be combined to form further embodiments of the invention.

What is claimed is:

1. A method for providing automated advertisement services using distributed advertisement stations for shared advertising among public service users comprising:
obtaining identity information for a target advertisement station;
loading a first advertisement schedule of said target advertisement station and transmitting to display said first advertisement schedule to a terminal device of a service user including available advertising time slots and available advertising methods;
receiving an advertisement request from said service user including designed advertising method, selected time slot, and plan for advertisement playing;
receiving user submitted advertisement data, and updating said first advertisement schedule to a second advertisement schedule for said target advertisement station by incorporating said advertisement request;
controlling to play said user submitted advertisement data on said target advertisement station according to said second advertisement schedule.

2. The method of claim 1, wherein said obtaining identity information for said target advertisement station comprises at least one of the steps of:
capturing a barcode associated to an advertisement device of said target advertisement station using said terminal device of said service user, and transmitting identity message contain said barcode information to an advertisement management controller of said target advertisement station;
capturing a barcode associated to an advertisement station using said terminal device of said service user, and transmitting identity message contain said barcode information to an advertisement system server;
pairing with a network controller of said target advertisement station using said terminal device of said service user via wireless network;
identifying said target advertisement station by position;
identifying said target advertisement station by ID.

3. The method of claim 1, wherein said advertisement schedule of said target advertisement station comprises:
base advertisement cycle;
advertisement play cycle;
advertisement playing sequence for each of said play cycle;
advertising channels;
unavailable time slots over said advertising channels;
available time slots over said advertising channels.

4. The method of claim 1, wherein said advertising method is determined by advertising channels available from said target advertisement station; and wherein said advertising channels comprise at least one of:
image and video playing channel;
audio playing channel;
lighting channel;
haptic channel;
projector channel;
electro-mechanical equipment operation channel;
user specified channel.

5. The method of claim 1, wherein said advertisement request from said service user is generated from said terminal device comprising at least one of the steps of:
specifying a play cycle to determine the time frequency for playing said advertisement data on said target advertisement station;
specifying a time period for playing said advertisement data on said target advertisement station;
specifying an event condition for playing said advertisement data on said target advertisement station;
specifying property attributes for said advertisement data including category, style and target audience;
specifying an advertisement time section in an available advertisement time segment of said time period to partition said available advertisement time segment into available time slots;
making time slot selection over advertising channels for playing said advertisement data;
specifying advertising duration to determine expiration date and time of said advertisement request;
selecting and confirming advertising budget plan.

6. The method of claim 1 further comprises a first event based advertising method to enable audience-oriented advertising comprising the steps of:
obtaining at least one video stream from at least one camera device associated to said advertisement station;
carrying out human and object detection and tracking in said at least one video stream, identifying human characteristics and recognizing activities;
carrying out statistical analysis and synthesizing a present event condition based on human characteristics, objects and recognized activities;
and wherein said first event based advertising method further comprises at least one of:
carrying out statistical analysis and predicting a future event condition based on human characteristics, objects and recognized activities;
identifying best-fitting advertisements based on said present event condition and advertisement-audience-relationship evaluations;
rearranging advertising schedule to prioritize the play of at least one of said best-fitting advertisements over a sequence of advertisements;
identifying inappropriate advertisements based on said present event condition and advertisement-audience-relationship evaluations;
rearranging advertising schedule to avoid the play of said inappropriate advertisements in the presence of said present event condition;
identifying best-fitting advertisement style based on said present event condition and advertisement-audience-relationship evaluations;
changing the advertising style for at least one advertisement over a sequence of advertisements;
identifying best-fitting advertisements based on said future event condition and advertisement-audience-relationship evaluations;
rearranging advertising schedule to align the play of at least one of said best-fitting advertisements over a sequence of advertisements with the predicted occurrence of said future event condition;
identifying best-fitting advertisement style based on said future event condition and advertisement-audience-relationship evaluations;
planning on changing the advertising style for at least one advertisement over a sequence of advertisements in accord with the predicted occurrence of said future event condition.

7. The method of claim 1 further comprises a second event based advertising method to enable environment-oriented advertising comprising the steps of:
obtaining measurement data from sensors associated to said advertisement station;
obtaining information data from connected information sources;
carrying out signal processing and statistical analysis to recognize present surrounding environment and time conditions;
synthesizing said present surrounding environment and time conditions to model a present event condition;
and wherein said second event based advertising method further comprises at least one of:
carrying out signal processing and statistical analysis to predict future surrounding environment and time conditions;
synthesizing said present surrounding environment and time conditions to model a future event condition;
identifying best-fitting advertisements based on said present event condition and advertisement-environment-relationship evaluations;
rearranging advertising schedule and sequence to prioritize playing at least one of said best-fitting advertisements;
identifying inappropriate advertisements based on said present event condition and advertisement-audience-relationship evaluations;
rearranging advertising schedule to avoid the play of said inappropriate advertisements in the presence of said present event condition;
identifying best-fitting advertisement style based on said present event condition and advertisement-environment-relationship evaluations;
changing the advertising style for at least one advertisement over a sequence of advertisements;
identifying best-fitting advertisements based on said future event condition and advertisement-environment-relationship evaluations;
rearranging advertising schedule and sequence to align play of at least one of said best-fitting advertisements with the predicted occurrence of said future event condition;
identifying best-fitting advertisement style based on said future event condition and advertisement-environment-relationship evaluations;
planning on changing the advertising style for at least one advertisement over a sequence of advertisements in accord with the predicted occurrence of said future event condition.

8. The method of claim 1 further comprises an advertisement authorization method comprising the steps of:
generating advertisement approval request containing ID of said target advertisement station, user account information and raw advertisement data;
sending advertisement approval request to an advertisement authorization server;
retrieving a station code of said target advertisement station;
processing said raw advertisement data and approving said advertisement approval request by satisfying a set of advertising criteria;
generating said advertisement data by embedding authorized advertisement ID, said station code of said target advertisement, and said raw advertisement data;
and wherein said advertisement authorization method further comprises at least one of:
transmitting said advertisement data to said target advertisement station;
transmitting said advertisement data to said service user to enable user submission of said advertisement data to said target advertisement station.

9. The method of claim 1 further comprises an advertisement inquiry method comprising the steps of:
detecting an event of advertisement inquiry comprising an advertisement ID;
processing received advertisement inquiry to identify advertisement information matching condition;
retrieving advertisement information data from an advertisement system database for at least one best-matching advertisement;
and wherein said advertisement inquiry method further comprises at least one of:
rearranging advertising schedule to prioritize playing said advertisement information data on said target advertisement station;
transmitting said advertisement information data to said terminal device of said service user.

10. The method of claim 1 further comprises an automatic advertisement design and generation method comprising at least one of the steps of:
receiving advertisement configuration data from said terminal device of said service user to generate a draft advertising proposal including advertisement format, style and playing methods;
receiving advertisement description data from said terminal device of said service user and generating advertisement design template for said draft advertising proposal including a sequence of advertisement playing episodes with assigned data playing channels;
receiving user input pattern from said terminal device of said service user and generating advertisement component data from an advertisement design server;
receiving advertisement design instruction from said terminal device of said service user and making change to refine said advertisement component data;
adding an advertisement material received from said terminal device of said service user to said draft advertising proposal using said advertisement design template;
adding said advertisement component data to said draft advertising proposal using said advertisement design template;
synthesizing said draft advertising proposal to generate deployable advertisement data.

11. A system for providing automated advertisement services using distributed advertisement stations for shared advertising among public service users comprising:
memory, configure to store advertisement schedule and data;
a network controller;
at least one advertisement device;
an advertisement management controller, contains at least one processor operably coupled to said memory, and said network controller, and said at least one advertisement device to execute a first program of instructions, wherein when said first program of instructions are executed, carries out the steps of:
obtaining identity information for a target advertisement station among said distributed advertisement stations;
loading a first advertisement schedule of said target advertisement station and transmitting via said network controller to display said first advertisement schedule to a terminal device of a service user including available advertising time slots and available advertising methods;
receiving an advertisement request from terminal device of said service user including designed advertising method, selected time slot, and plan for advertisement playing;
receiving user submitted advertisement data, and updating said first advertisement schedule to a second advertisement schedule for said target advertisement station by incorporating said advertisement request;
controlling to play said user submitted advertisement data on said at least one advertisement device according to said second advertisement schedule.

12. The system of claim 11, wherein said advertisement device comprises at least one of:
a stationary image and video displaying device;
a mobile image and video displaying device;
a group of image-video-displaying devices;
an audio playing device;
an image projecting device;
a lighting device;
a picture displaying board.

13. The system of claim 11, wherein said advertisement device further comprises accessory subsystems of at least one of:
image and video playing subsystem;
image and video partitioning and playing subsystem;
audio playing subsystem;
lighting and lighting pattern control subsystem;
haptic and motion control subsystem;
image projector and image projecting control subsystem;
electro-mechanical equipment and operation subsystem;
user specified subsystem.

14. The system of claim 11, wherein said system for providing automated advertisement services is a networked advertisement service system that further comprises an advertisement system server; and wherein said advertisement system server operably coupled to said memory, said network controller and said at least one processor to provide advertising management for said advertisement management controllers of a group of distributed advertisement stations.

15. The system of claim 11, wherein said at least one advertisement device further comprise at least one camera operably coupled to said processor to execute said a second program of instructions, wherein when said second program of instructions are executed, carries out the steps of:
obtaining at least one video stream from said at least one camera;
carrying out human and object detection and tracking in said at least one video stream, identifying human characteristics, and recognizing activities;
carrying out statistical analysis and synthesizing a present event condition based on human characteristics, objects and recognized activities;
and wherein said second program of instructions are executed, further carries out at least one of steps of:
carrying out statistical analysis and predicting a future event condition based on human characteristics, objects and recognized activities;
identifying best-fitting advertisements based on said present event condition and advertisement-audience-relationship evaluations;
rearranging advertising schedule to prioritize the play of at least one of said best-fitting advertisements over a sequence of advertisements;
identifying inappropriate advertisements based on said present event condition and advertisement-audience-relationship evaluations;
rearranging advertising schedule to avoid the play of said inappropriate advertisements in the presence of said present event condition;
identifying best-fitting advertisement style based on said present event condition and advertisement-audience-relationship evaluations;
changing the advertising style for at least one advertisement over a sequence of advertisements;
identifying best-fitting advertisements based on said future event condition and advertisement-audience-relationship evaluations;
rearranging advertising schedule to align the play of at least one of said best-fitting advertisements over a sequence of advertisements with the predicted occurrence of said future event condition;
identifying best-fitting advertisement style based on said future event condition and advertisement-audience-relationship evaluations;
planning on changing the advertising style for at least one advertisement over a sequence of advertisements in accord with the predicted occurrence of said future event condition.

16. The system of claim 11, wherein said at least one advertisement device further comprise sensors and connected information sources operably coupled to said processor to execute said a third program of instructions, wherein when said third program of instructions are executed, carries out the steps of:
obtaining measurement data from said sensors;
obtaining information data from said connected information sources;
carrying out signal processing and statistical analysis to recognize present surrounding environment and time conditions;
synthesizing said present surrounding environment and time conditions to model a present event condition;
and wherein said second event based advertising method further comprises at least one of:
carrying out signal processing and statistical analysis to predict future surrounding environment and time conditions;
synthesizing said present surrounding environment and time conditions to model a future event condition;
identifying best-fitting advertisements based on said present event condition and advertisement-environment-relationship evaluations;
rearranging advertising schedule and sequence to prioritize playing at least one of said best-fitting advertisements;
identifying inappropriate advertisements based on said present event condition and advertisement-audience-relationship evaluations;
rearranging advertising schedule to avoid the play of said inappropriate advertisements in the presence of said present event condition;
identifying best-fitting advertisement style based on said present event condition and advertisement-environment-relationship evaluations;
changing the advertising style for at least one advertisement over a sequence of advertisements;
identifying best-fitting advertisements based on said future event condition and advertisement-environment-relationship evaluations;
rearranging advertising schedule and sequence to align play of at least one of said best-fitting advertisements with the predicted occurrence of said future event condition;
identifying best-fitting advertisement style based on said future event condition and advertisement-environment-relationship evaluations;
planning on changing the advertising style for at least one advertisement over a sequence of advertisements in accord with the predicted occurrence of said future event condition.

17. The system of claim 11, wherein said at least one advertisement device further comprise an electro-mechanical equipment operably connected to said processor and said memory through an IO device; and wherein said processor executes a forth program of instructions, carrying out the execution of at least one of:
adding an electro-mechanical equipment channel as a device operation type of advertisement channel to said advertisement schedule;
adding an electro-mechanical equipment operation as an advertisement method to a library of advertising methods;
updating said advertisement schedule with user selection on said electro-mechanical equipment channel by incorporating said advertisement request;
operating said electro-mechanical equipment to play said advertisement data at said device operation type of advertisement channel according to said advertisement schedule and said designed advertising method.

18. The system of claim 11 further comprises an advertisement authorization server containing at least one processor operably coupled to said memory and said network controller to execute a fourth program of instructions, wherein when said fourth program of instruction is executed, carries out the steps of:
receiving advertisement approval request containing ID of said target advertisement station, user account information and raw advertisement data;
retrieving a station code of said target advertisement station;
processing said raw advertisement data and approving said advertisement approval request by satisfying a set of advertising criteria;
generating said advertisement data by embedding authorized advertisement ID, said station code and said raw advertisement data;
and wherein said advertisement authorization method further comprises at least one of:
transmitting said advertisement data to said target advertisement station;
transmitting said advertisement data to said service user to enable user submission of said advertisement data to said target advertisement station.

19. The system of claim 11 further comprises an advertisement information server containing at least one processor operably coupled to said memory and said network controller to execute a fifth program of instructions, wherein when said fifth program of instructions are executed, carries out the steps of:
detecting an event of advertisement inquiry comprising an advertisement ID;
processing received advertisement inquiry to identify advertisement information matching condition;
retrieving advertisement information data from an advertisement system database for at least one best-matching advertisement;
and wherein said advertisement inquiry method further comprises at least one of:
rearranging advertising schedule to prioritize playing said advertisement information data on said target advertisement station;
transmitting said advertisement information data to said terminal device of said service user.

20. The system of claim 11 further comprises an advertisement generation server containing at least one processor operably coupled to said memory and said network controller to execute a sixth program of instructions, wherein when said sixth program of instructions are executed, carries out at least one of the steps of:
receiving advertisement configuration data from said terminal device of said service user to generate a draft advertising proposal including advertisement format, style and playing methods;
receiving advertisement description data from said terminal device of said service user and generating advertisement design template for said draft advertising proposal including a sequence of advertisement playing episodes with assigned data playing channels;
receiving user input pattern from said terminal device of said service user and generating advertisement component data from an advertisement design server;
receiving advertisement design instruction from said terminal device of said service user and making change to refine said advertisement component data;
adding an advertisement material received from said terminal device of said service user to said draft advertising proposal using said advertisement design template;
adding said advertisement component data to said draft advertising proposal using said advertisement design template;
synthesizing said draft advertising proposal to generate deployable advertisement data.
